(19) United States
(12) Patent Application Publication
(10) Pub. No.: US 2025/0240343 A1
(43) Pub. Date: Jul. 24, 2025

(54) METHOD OF JOINT COMPUTATION OFFLOADING AND RESOURCE ALLOCATION IN MULTI-EDGE SMART COMMUNITIES WITH PERSONALIZED FEDERATED DEEP REINFORCEMENT LEARNING

(71) Applicant: FUZHOU UNIVERSITY, Fuzhou (CN)

(72) Inventors: Zheyi CHEN, Fuzhou (CN); Bing XIONG, Fuzhou (CN); Junjie ZHANG, Fuzhou (CN); Zhiqin HUANG, Fuzhou (CN); Pengfei WANG, Fuzhou (CN)

(73) Assignee: FUZHOU UNIVERSITY, Fuzhou (CN)

(21) Appl. No.: 18/582,690

(22) Filed: Feb. 21, 2024

(30) Foreign Application Priority Data
Jan. 23, 2024 (NL) 2036872

(51) Int. Cl. H04L 67/1008; H04L 41/16

(52) U.S. Cl. CPC H04L 67/1008; H04L 41/16

(57) ABSTRACT

A new multi-edge smart community system consisting of communication, computing, and energy harvesting models, where the task execution delay and energy consumption are formalized as the optimization objectives under multiple constraints. For single-edge scenarios, we propose an improved twin-delayed DRL-based algorithm. For multi-edge scenarios, we develop a novel personalized FL-based training framework for DRL. Using the real-world settings and testbed, extensive experiments are conducted to validate the effectiveness of the proposed PFR-OA. The results show that the PFR-OA achieves better trade-offs between delay and energy consumption and exhibits higher task execution success rates than benchmark methods under different scenarios. Notably, the PFR-OA reaches a faster convergence speed compared to advanced DRL-based and FRL-based methods. Moreover, we further verify the practicality and superiority of the PFR-OA via real-world testbed experiments.

### CROSS REFERENCE TO THE RELATED APPLICATIONS

This application is based upon and claims priority to Netherlandish Patent Application No. N2036872, filed on Jan. 23, 2024, the entire contents of which are incorporated herein by reference.

### TECHNICAL FIELD

The present invention belongs to the technical field of Mobile edge computing, in particular relates to a method of joint computation offloading and resource allocation in multi-edge smart communities with personalized federated deep reinforcement learning.

### BACKGROUND

Smart cities use intelligent technologies to empower community governance and services for improving the efficiency of community running and the quality of citizens' lives. In smart communities, End Devices (EDs) are interconnected through wireless links, forming the Internet-of-Things (IoT). The EDs commonly own certain capabilities of data collection and task processing that can support emerging intelligent applications to some extent, such as smart transport, smart grids, and autonomous driving. However, due to the limited capacities of computing and power storage on EDs, it is hard to meet the high demands of intelligent applications for low delay and sustainable processing. In classic cloud computing, computation intensive and delay-sensitive tasks on EDs are usually up-loaded to the remote cloud with sufficient resources for execution. However, the long transmission distance between EDs and the cloud often leads to excessive delay, which seriously degrades Quality-of-Service (QoS).

To alleviate the contradiction between the high demands of intelligent applications and the limited capacities of EDs, the integration of the emerging Mobile Edge Computing (MEC) with Wireless Power Transmission (WPT) is deemed as a feasible and promising solution. In MEC, more computing resources are deployed at the network edge close to EDs, which can extend the computing capacities of EDs by offloading their tasks to MEC servers for execution. Meanwhile, EDs can be charged via WPT to maintain their power demands for long-term running. However, MEC servers are equipped with fewer resources compared to cloud data centers, and thus excessive delay may happen if too many tasks are offloaded simultaneously. Moreover, offloading decisions are constrained and affected by many factors such as the attributes and characteristics of tasks, the power storage of EDs, and the available resource status of MEC servers. Therefore, it is extremely challenging to design an effective and efficient solution for computation offloading and resource allocation in complex and dynamic MEC environments with multiple constraints.

Most of the classic solutions for computation offloading and resource allocation are based on rules, heuristics, and control theory. Although they can handle this complex problem to some extent, they commonly rely on some prior knowledge of systems (e.g., state transitions, demand changes, and energy consumption) to formulate appropriate policies for computation offloading and resource allocation. Therefore, they may work well in specific scenarios but cannot well fit in real-world MEC systems with high dynamics and complexity, causing degraded QoS and excessive system overheads. In contrast, Deep Reinforcement Learning (DRL) can better adapt to MEC environments and make policies with higher generalization abilities. Recently, there have been some DRL-based studies on computational offloading and resource allocation. Most of them adopted value-based DRL methods such as Deep Q-Network (DQN) and Double Deep Q-Network (DDQN), whose action space grows exponentially with the increasing number of EDs, resulting in huge complexity. Moreover, the value-based DRL discretizes the continuous space of resource allocation, which may lead to inaccurate policies and undesired results. To better cope with the problem of continuous control, some studies used policy-based DRL methods such as Deep Deterministic Policy Gradient (DDPG), which avoids exponential growth in action space by separating action selection and value evaluation. However, the policy-based DRL is prone to the Q-value overestimation issue, which may cause great fluctuations in the training process and policies falling into the local optimum.

Moreover, most of the existing solutions commonly adopted a centralized training manner, where all the information about EDs may need to be uploaded to a central server. This manner enables models to perform well with rich training samples but might cause severe network congestion and privacy leakage. To ameliorate this problem, some distributed training manners (e.g., multi-agent DRL) can be deemed as potentially feasible research directions. In multi-agent DRL, each agent regards other agents as environment variables and interacts with the environment independently, and then uses the feedback from the environment to improve its policy. However, when some agents lack training samples, the performance of local models will be seriously limited, making it hard to efficiently achieve model convergence. In contrast, Federated Reinforcement Learning (FRL) implements a collaborative model training on data silos with the original purpose of privacy protection. With FRL, MEC servers only upload their model updates to a central server for federated aggregation, and the aggregated global model will be distributed to MEC servers for the next round of training on a single agent. Therefore, the FRL can achieve comparable results to the centralized training manner at a faster convergence speed, which can also improve the issue of lacking training samples. However, different smart communities may own personalized demands on QoS and system overheads, and the classic FRL cannot handle this problem because it just naively averages model parameters over MEC servers.

### SUMMARY

The purpose of the present invention is to provide a method of joint computation offloading and resource allocation in multi-edge smart communities with personalized federated deep reinforcement learning, design a new multi-edge smart community system consisting of communication, computing, and energy harvesting models, where the task execution delay and energy consumption are formalized as the optimization objectives under multiple constraints;
for single-edge scenarios, propose an improved twin-delayed DRL-based algorithm; we design a new proximal term to improve the way of only optimizing local Q-value loss function in classic DRL, and reduce the variance of action-value estimation by decreasing the frequency of network updates;
for multi-edge scenarios, develop a novel personalized FL-based training framework for DRL; during the training process, consider the personalized demands of smart communities on QoS and system overheads; the proposed proximal term can attenuate the effect of local update dispersion, enabling the training to quickly converge to the global optimum; design a new partial-greedy based participant selection mechanism, which reduces the complexity of federated aggregation and endows the training with sufficient exploration ability.

The proposed system of multi-edge smart communities consists of a Central Base Station (C-BS) and m smart communities, denoted by the set R={Rᵢ, i∈m}; in the smart community Rᵢ, an Access Point (AP) interacts with the C-BS and there are n EDs, denoted by the set EDᵢ={ED_{i,j}, i∈m, j∈n}; each AP is equipped with an MEC server (denoted by Mᵢ) that can process the tasks offloaded by EDs and feedback results, and it can also transmit energy to the EDs within its communication coverage through the wireless network, each ED is equipped with a rechargeable battery that can receive and store energy to power the processes of task offloading and processing;
adopt a discrete-time running mode, which contains H time-slots with the same span, where h=1, 2, . . . , H; at the beginning of h, ED_{i,j} generates a task, denoted by Task_{i,j} (h)=(D_{i,j} (h), C_{i,j} (h), T_{d}), where D_{i,j} (h) indicates the data volume, C_{i,j} (h) indicates the required computational resources, and T_{d} indicates the maximum tolerable delay; if a task cannot be completed within maximum tolerable delay and available power, it will be determined to be failed; the tasks generated by ED_{i,j} will be placed in its buffer queue, and the tasks that first enter the queue will be completed before subsequently arriving tasks can be executed; tasks can be processed locally or offloaded to the MEC server for execution; divide each time-slot into T sub-slots for fine-grained model training, where t=1, 2, . . . , T, aiming to avoid excessive delays or task failures caused by inappropriate coarse-grained decisions; when there are more sub-slots, the waiting time for the tasks on the buffer queue might be reduced with better policies, but it will increase the complexity and time of model training, the values of T should be properly chosen for different requirements and scenarios.

When uploading Task_{i,j}(h) to Mᵢ for execution via the AP in Rᵢ, the uplink date rate of ED_{i,j} is defined as

$${r}_{i , j} ( t ) = {w}_{i , j} ( t ) {B}_{i} ( t ) {log}_{2} ( 1 + \frac{{P}_{i , j} ( t ) {g}_{i , j} ( t )}{{σ}^{2} {l}_{i , j} ( t )} ) \qquad ( 1 )$$

where Bᵢ(t) indicates the available upload bandwidth at the sub-slot t, w_{i,j}(t) indicates the proportion of bandwidth allocated to Task_{i,j}(h), P_{i,j}(t) indicates the transmission power of ED_{i,j}, g_{i,j}(t) indicates the channel gain between Mᵢ and ED_{i,j}, σ² indicates the average power of Gaussian white noise, and l_{i,j}(t) indicates the distance between Mᵢ and ED_{i,j};
the delay of uploading Task_{i,j}(h) is defined as

$${T}_{i , j}^{t r} ( h ) = \frac{{D}_{i , j} ( h )}{{r}_{i , j} ( t )} \qquad ( 2 )$$

accordingly, the energy consumption of uploading Task_{i,j}(h) is defined as

$${E}_{i , j}^{t r} ( h ) = {P}_{i , j} ( t ) {T}_{i , j}^{t r} ( t ) . \qquad ( 3 )$$

In the proposed model, all EDs and MEC servers can offer computing services, thus consider the local and edge computing modes as follows:
when a task is executed on an ED, the delay and energy consumption of executing the task are defined as

$${T}_{i , j}^{l} ( h ) = \frac{{C}_{i , j} ( h )}{{f}_{i , j}} \qquad ( 4 )$$

$${E}_{i , j}^{l} ( h ) = k {C}_{i , j} ( h ) {f}_{i , j}^{2} \qquad ( 5 )$$

where f_{i,j} indicates the computing capability (i.e., CPU frequency) of ED_{i,j} and k is the capacitance coefficient;
when offloading a task to the MEC server for execution, the delay and energy consumption of executing the task are defined as

$${T}_{i , j}^{m} ( h ) = \frac{{C}_{i , j} ( h )}{{β}_{i , j} ( t ) {F}_{i} ( t )} \qquad ( 6 )$$

$${E}_{i , j}^{m} ( h ) = {P}_{m} {T}_{i , j}^{m} ( h ) \qquad ( 7 )$$

where β_{i,j}(t) indicates the proportion of computational resources allocated by Mᵢ to Task_{i,j}(h), Fᵢ(t) indicates the available computational resources of Mᵢ, and Pₘ indicates the computing power of Mᵢ.

In the proposed system, all EDs are equipped with rechargeable batteries with a maximum capacity of bₘₐₓ; at the beginning of t, the battery power of ED_{i,j} is b_{i,j}(t); during the process of harvesting energy, ED_{i,j} receives energy through WPT and deposits it into the battery in the form of energy packets, and the amount of harvested energy by an ED during t is denoted as eₜ, which can be used to execute tasks locally or offload tasks to Mᵢ for execution; for different system states during t, consider different situations of power variations on ED_{i,j} as follows;
if the task buffer queue of ED_{i,j} is empty, there is only charging but no energy consumption; thus, at the beginning of t+1, the battery power of ED_{i,j} is

$${b}_{i , j} ( t + 1 ) = min ( {b}_{i , j} ( t ) + {e}_{t} , {b}_{max} ) \qquad ( 8 )$$

if Task_{i,j}(h) is completed on ED_{i,j}, the battery power of ED_{i,j} at the beginning of t+1 is

$${b}_{i , j} ( t + 1 ) = min \{ max \{ {b}_{i , j} ( t ) + {e}_{t} - {E}_{i , j}^{l} ( h ) , 0 \} , {b}_{max} \} \qquad ( 9 )$$

if Task_{i,j}(h) fails on ED_{i,j} because T_{i,j}^{l}(h) exceeds T_{d} or E_{i,j}^{l}(h) exceeds b_{i,j}(t), the battery power of ED_{i,j} at the beginning of t+1 is

$${b}_{i , j} ( t + 1 ) = min \{ max \{ {b}_{i , j} ( t ) + {e}_{t} - {E}_{i , j}^{l} ( h ) , 0 \} , {b}_{max} \} \qquad ( 10 )$$

if Task_{i,j}(h) is offloaded to Mᵢ and be completed successfully, the battery power of ED_{i,j} at the beginning of t+1 is

$${b}_{i , j} ( t + 1 ) = min \{ max \{ {b}_{i , j} ( t ) + {e}_{t} - {E}_{i , j}^{tr} ( h ) - {E}_{i , j}^{m} , 0 \} , {b}_{max} \} \qquad ( 11 )$$

if Task_{i,j}(h) fails because T_{i,j}^{tr}(h) exceeds T_{d} or E_{i,j}^{tr}(h) exceeds b_{i,j}(t), the battery power of ED_{i,j} at the beginning of t+1 is

$${b}_{i , j} ( t + 1 ) = min \{ max \{ {b}_{i , j} ( t ) + {e}_{t} - \frac{\frac{h}{T}}{{T}_{i , j}^{tr} ( h )} {E}_{i , j}^{tr} ( h ) , 0 \} , {b}_{max} \} \qquad ( 12 )$$

if Task_{i,j}(h) fails on Mᵢ because T_{i,j}^{m}(h) exceeds T_{d} or E_{i,j}^{m}(h) exceeds b_{i,j}(t), the battery power of ED_{i,j} at the beginning of t+1 is

$${b}_{i , j} ( t + 1 ) = min \{ max \{ {b}_{i , j} ( t ) + {e}_{t} - {E}_{i , j}^{tr} ( h ) - \frac{\frac{h}{T} - {T}_{i , j}^{tr} ( h )}{{T}_{i , j}^{m} ( h )} {E}_{i , j}^{tr} ( h ) , 0 \} , {b}_{max} \} . \qquad ( 13 )$$

Based on the above system models, the delay and energy consumption of executing a task with different offloading decisions are respectively defined as

$${T}_{i , j} ( h ) = ( 1 - {α}_{i , j} ( t ) ) {T}_{i , j}^{l} ( h ) + {α}_{i , j} ( t ) ( {T}_{i , j}^{tr} ( h ) + {T}_{i , j}^{m} ( h ) ) \qquad ( 14 )$$

$${E}_{i , j} ( h ) = ( 1 - {α}_{i , j} ( t ) ) {E}_{i , j}^{l} ( h ) + {α}_{i , j} ( t ) ( {E}_{i , j}^{tr} ( h ) + {E}_{i , j}^{m} ( h ) ) \qquad ( 15 )$$

where α_{i,j}(t)∈{0, 1} is the offloading decision, which indicates that a task will be executed locally or offloaded to the MEC server for execution; to minimize the delay and energy consumption of executing tasks, the optimization objective is formulated as

$$\begin{matrix}( P 1 ) {min}_{α , β , w} {\sum }_{j = 1}^{n} {\sum }_{h = 0}^{H} {q}_{i , t} {T}_{i , j} ( h ) + {q}_{i , e} {E}_{i , j} ( h ) \\ s . t . C 1 : {α}_{i , j} ( t ) ∈ \{ 0 , 1 \} \\ C 2 : {T}_{i , j} ( h ) \leq {T}_{d} \\ C 3 : {E}_{i , j} ( h ) \leq {b}_{i , j} ( t ) \\ C 4 : {\sum }_{i = 1}^{N} {α}_{i , j} ( t ) {w}_{i , j} ( t ) = 1 \\ C 5 : {\sum }_{i = 1}^{N} {α}_{i , j} ( t ) {β}_{i , j} ( t ) = 1\end{matrix} \qquad ( 16 )$$

where q_{i,t} and q_{i,e} indicate the weights of delay and energy consumption, respectively; C1 indicates that a task can only be executed locally or offloaded to the MEC server for execution; C2 indicates that the delay of executing a task cannot exceed the maximum tolerable delay; C3 indicates that the energy consumption of executing a task cannot exceed the available battery power of an ED; C4 indicates that the sum of the proportion of bandwidth allocated for uploading tasks should be 1; C5 indicates that the sum of the proportion of the computational resources allocated for executing offloaded tasks should be 1.

The DRL agent selects actions under different states by interacting with the single-edge environment and continuously optimizes the policies of computation offloading and resource allocation referring to the reward signals from the environment; accordingly, the state space, action space, and reward function for DRL are defined as follows;
state space: at sub-slot t, the system state is defined as

$${s}_{i} ( t ) = \{ {D}_{i} ( t ) , {C}_{i} ( t ) , {b}_{i} ( t ) , {l}_{i} ( t ) , {B}_{i} ( t ) , {F}_{i} ( t ) , {q}_{i} \} \qquad ( 17 )$$

where Dᵢ(t)={D_{i,j}(t), j∈N} indicates the set of data volumes for all tasks, Cᵢ(t)={C_{i,j}(t), j∈N} indicates the set of required computational resources for all tasks, bᵢ(t)={b_{i,j}(t), j∈N} indicates the set of battery power for all EDs, lᵢ(t)={l_{i,j}(t), j∈N} indicates the set of distances between Mᵢ and all EDs, Bᵢ(t) and Fᵢ(t) indicate the available bandwidth and computational resources of Mᵢ, respectively, and qᵢ={q_{i,t}, q_{i,e}, q_{i,p}} indicates the personalized demands for delay, energy consumption, and task success rate;
action space: at sub-slot t, the DRL agent makes an action of computation offloading and resource allocation based on the current system state, which is defined as

$${a}_{i} ( t ) = \{ {α}_{i} ( t ) , {w}_{i} ( t ) , {β}_{i} ( t ) \} \qquad ( 18 )$$

where αᵢ(t) indicates the set of offloading decisions for all tasks, and wᵢ(t) and βᵢ(t) indicate the sets of the proportion of bandwidth and computational resources allocated to all tasks, respectively;
reward function: the optimization objective of P1 is to minimize the weighted sum of delay and energy consumption; thus, at sub-slot t, the instant reward of processing a task is defined as

$${r}_{i , j} ( t ) = \{ \begin{matrix}- ( {q}_{i , t} {T}_{i , j} ( h ) + {q}_{i , e} {E}_{i , j} ( h ) ) , & Succeed \\ - {q}_{i , p} , & Unsatisfy C 2 \\ - {q}_{i , p} , & Unsatisfy C 3\end{matrix} \qquad ( 19 )$$

if a task can be successfully completed, the instant reward will be the opposite of the weighted sum of delay and energy consumption; if C2 or C3 cannot be satisfied, the instant reward will be q_{i,p}, which is used as the penalty for failing to complete the task; the long-term reward is defined as

$${r}_{i} ( t ) = {\sum }_{j = 1}^{N} {\sum }_{h = 1}^{H} {γ}^{t} {r}_{i , j} ( t ) \qquad ( 20 )$$

where γ^{t} is the discount factor.

The main steps of the proposed improved twin-delayed DRL-based computation offloading and resource allocation algorithm as follows: first, the actor's network μᵢ and two critic's networks Q_{i,1} and Q_{i,2} are initialized, and the target actor's network μᵢ′ and two target critic's networks Q_{i,1}′ and Q_{i,2}′ are initialized accordingly; introduce two critic's networks that separate action selection and Q-value update, aiming to improve the training stability; than initialize the number of training epoch P, the number of time-slots H, the number of sub-slots T, the update frequencies of FL fₚ and the actor's network fₐ, the replay buffer Gᵢ, the batch size N and the learning rate τ; for each training epoch, when it comes to the round of FL update, μᵢ(s|θ^{μ}^{ᵢ}), Q_{i,1}(s, a|θ^{Q}^{_{i,1}}), and Q_{i,2}(s, a|θ^{Q}^{_{i,2}}) are uploaded to the C-BS; next, obtain aggregated models Q_{f,1}(s, a|θ^{Q}^{_{f,1}}), Q_{f,2}(s, a|θ^{Q}^{_{f,2}}), and μ_{f}(s|θ^{μ}^{_{f}}), which are used to replace local models by soft update; for each sub-slot, the state sᵢ(t) is first input to μᵢ to obtain an action of computation offloading and resource allocation aᵢ(t) and execute this action in the environment, which will feedback the instant reward and the next state sᵢ(t+1) based on execution results; next, the state-transition process is stored in Gᵢ, where N samples are randomly selected to train network parameters, and then the target actor's network is used to get the next action; the proposed algorithm uses the critic's network to fit Qᵢ(s(t), a(t)), which can accurately reflect the Q-values of each action; use the actor's network to fit the mapping between s(t) and a(t), and thus the DRL agent can take proper actions at different states and maximize the long-term reward; introduce the Gaussian noise in the target actor's network to obtain a(t+1), and this process is defined as

$${a}_{i} ( t + 1 ) = {μ}_{i} ( s ( t + 1 ) \vert {θ}^{{μ}_{i}^{′}} ) + {ε}_{2} , {ε}_{2} \sim clip ( N ( 0 , {σ}_{2} ) , - c , c ) \qquad ( 21 )$$

where the actor's network is endowed with sufficient exploration of selecting target actions by adding noise;
the target Q-value is calculated by considering the current reward and comparing two critic's networks, which is defined as

$${y}_{traget} ← r ( t ) + γ {min}_{z = 1 , 2} {Q}_{i , z} ( s ( t + 1 ) , a ( t + 1 ) \vert {θ}^{{Q}_{i , z}^{′}} ) \qquad ( 22 )$$

the critic's network is updated by the loss back-propagated of the difference between y_{target} and the current Q-value; design a proximal term to replace the original loss function that only tends to minimize the difference in local Q-values, the update process is defined as

$${θ}^{{Q}_{i , z}} ← arg {min}_{{θ}_{i , z}} ( {N}^{- 1} \sum {( {y}_{target} - {Q}_{i , z} ( s ( t ) , a ( t ) \vert {θ}^{{Q}_{i , z}} ) )}^{2} ) + \frac{{λ}_{{Q}_{i , z}}}{2} {‖ {θ}^{{Q}_{i , z}} - {θ}^{{Q}_{f , z}} ‖}^{2} . \qquad ( 23 )$$

Design a new personalized FL-based training framework to further improve the adaptiveness and training efficiency of the DRL-based computation offloading and resource allocation model for different environments; the proposed personalized FRL-based training framework as follow: initialize the federated actor's network f, two federated critic's networks Q_{f,1} and Q_{f,2}, the number of edges participating in FRL training K (K≤m), and the communication rounds for federated aggregation P_{f}; in each communication round, introduce a new proximal term to attenuate the dispersion of local updates, the process is defined as

$${θ}_{i}^{t + 1} \approx {min}_{{θ}_{i}^{t}} {h}_{i}^{t} ( {θ}_{i}^{t} ; {θ}_{f}^{r} ) = L ( {θ}_{i}^{t} ) + \frac{{λ}_{{θ}_{i}}}{2} {‖ {θ}_{i}^{t} - {θ}_{f}^{r} ‖}^{2} \qquad ( 24 )$$

where λ_{θ}_{ᵢ}={λ_{Q}_{_{i,1}}, λ_{Q}_{_{i,2}}, λ_{μ}_{ᵢ}} is the parameter set of the proximal term, use an adaptive tuning of λ_{θ}_{ᵢ}, indicating the loss changes of local models, to solve the issue of model heterogeneity; this design limits the iterative trajectories of local agents to avoid the training dispersion caused by the deviation of local models; in each communication round, each DRL model in Rᵢ(Rᵢ∈R) uploads the actor's network μᵢ(s|θ^{μ}^{ᵢ}) and two critic's networks Q_{i,1}(s, a|θ^{Q}^{_{i,1}}), and Q_{i,2}(s, a|θ^{Q}^{_{i,2}}) to the C-BS; next, sort DRL models by ascending order of their training loss, and then design a partial-greedy based participant selection mechanism, where the C-BS uses ε-greedy to select some DRL models for federated aggregation; select the DRL model with the lowest training loss by the probability of ε and randomly select DRL models in the other cases; the process of federated aggregation is defined as

$${Q}_{f , 1} ( s , a \vert {θ}^{{Q}_{f , 1}} ) = \frac{1}{K} {\sum }_{i ∈ {Z}_{r}} {Q}_{i , 1} ( s , a \vert {θ}^{{Q}_{i , 1}} ) , \qquad ( 25 )$$

$${Q}_{f , 2} ( s , a \vert {θ}^{{Q}_{f , 2}} ) = \frac{1}{K} {\sum }_{i ∈ {Z}_{r}} {Q}_{i , 2} ( s , a \vert {θ}^{{Q}_{i , 2}} ) ,$$

$${μ}_{f} ( s \vert {θ}^{{μ}_{f}} ) = \frac{1}{K} {\sum }_{i ∈ {Z}_{r}} {μ}_{i} ( s \vert {θ}^{{μ}_{i}} ) .$$

the C-BS distributes the aggregated DRL models to the DRL agents in each Rᵢ(Rᵢ∈R) and waits for the next communication round of FRL training.

### BRIEF DESCRIPTION OF THE DRAWINGS

FIG. 1 shows The proposed system of multi-edge smart communities;

FIG. 2 shows An example of time-slot division;

FIG. 3 shows Improved twin-delayed DRL-based computation offloading and resource allocation for single-edge scenarios;

FIG. 4 shows The proposed personalized FRL-based training framework;

FIGS. 5A-5B show Performance of PFR-OA with different hyperparameters;

FIG. 6 shows Convergence comparison among different methods;

FIGS. 7A-7C show Comparison of task success rate, average energy consumption, and average waiting time among different methods;

FIGS. 8A-8D show Performance comparison among different methods with various required computational resources of tasks;

FIGS. 9A-9D show Performance comparison among different methods with various harvested energies by an ED;

FIGS. 10A-10D show Performance comparison among different methods with various computing capabilities of a MEC server;

FIGS. 11A-11D show Performance comparison among different methods with various maximum tolerable delays of a task;

FIGS. 12A-12C show Construction of the real-world testbed with hardware devices;

FIG. 13 shows Performance comparison of different methods on the testbed.

### DETAILED DESCRIPTION OF THE EMBODIMENTS

The technical solution of the present invention is described in detail in combination with the accompany drawings.

Proposed in the present invention is a method of joint computation offloading and resource allocation in multi-edge smart communities with personalized federated deep reinforcement learning.

The method specifically comprises the following design process:

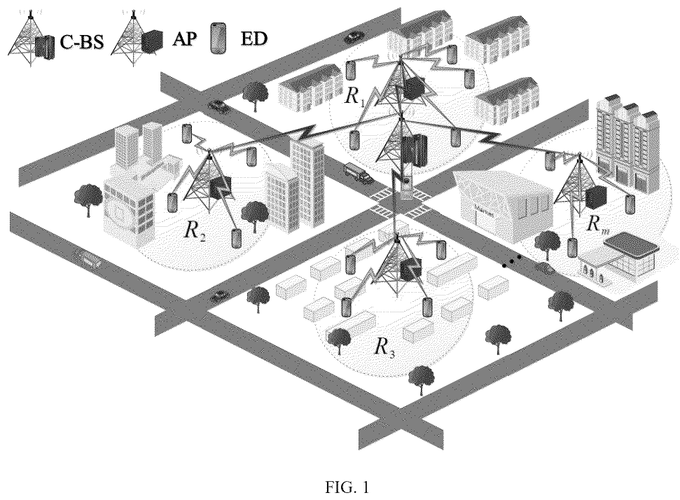

As shown in FIG. 1, the proposed system of multi-edge smart communities consists of a Central Base Station (C-BS) and m smart communities, denoted by the set R={Rᵢ, i∈m}. In the smart community Rᵢ, an Access Point (AP) interacts with the C-BS and there are n EDs, denoted by the set EDᵢ={ED_{i,j}, i∈m, j∈n}. Each AP is equipped with an MEC server (denoted by Mᵢ) that can process the tasks offloaded by EDs and feedback results, and it can also transmit energy to the EDs within its communication coverage through the wireless network. Moreover, each ED is equipped with a rechargeable battery that can receive and store energy to power the processes of task offloading and processing. For clarity, Table 1 lists the major notations used in the proposed model.

TABLE 1
Major notations used in the proposed model

| Notation | Definition |
|---|---|
| R | Set of smart communities |
| EDᵢ | Set of EDs in Rᵢ |
| Mᵢ | MEC server in Rᵢ |
| h | Time-slot |
| t | Sub-slot |
| Task_{i, j}(h) | A task generated by the j-th ED in Rᵢ |
| D_{i, j}(h) | Data volume of Task_{i, j}(h) |
| C_{i, j}(h) | Required computational resources of Task_{i, j}(h) |
| T_{d} | Maximum tolerable delay of Task_{i, j}(h) |
| r_{i, j}(t) | Uplink date rate of ED_{i, j} |
| w_{i, j}(t) | Proportion of bandwidth allocated to Task_{i, j}(h) |
| Bᵢ(t) | Available upload bandwidth |
| P_{i, j}(t) | Transmission power of ED_{i, j} |
| g_{i, j}(t) | Channel gain between ED_{i, j} and Mᵢ |
| σ² | Average power for Gaussian white noise |
| l_{i, j}(t) | Distance between ED_{i, j} and Mᵢ |
| T_{i, j}^{tr}(h) | Delay of uploading Task_{i, j}(h) |
| E_{i, j}^{tr}(h) | Energy consumption of uploading Task_{i, j}(h) |
| T_{i, j}^{l}(h) | Delay of executing Task_{i, j}(h) on ED_{i, j} |
| E_{i, j}^{l}(h) | Energy of executing Task_{i, j}(h) on ED_{i, j} |
| k | Capacitance coefficient |
| f_{i, j} | Computing capability (i.e., CPU frequency) of ED_{i, j} |
| T_{i, j}^{m}(h) | Delay of executing Task_{i, j}(h) by Mᵢ |
| E_{i, j}^{m}(h) | Energy consumption of executing Task_{i, j}(h) by Mᵢ |
| β_{i, j}(t) | Proportion of resources allocated to Task_{i, j}(h) |
| Fᵢ(t) | Available computational resources of Mᵢ |
| Pₘ | Computing power of Mᵢ |
| bₘₐₓ | Maximum battery capacity of an ED |
| b_{i, j}(t) | Battery power of ED_{i, j} |
| eₜ | Amount of harvested energy by an ED |

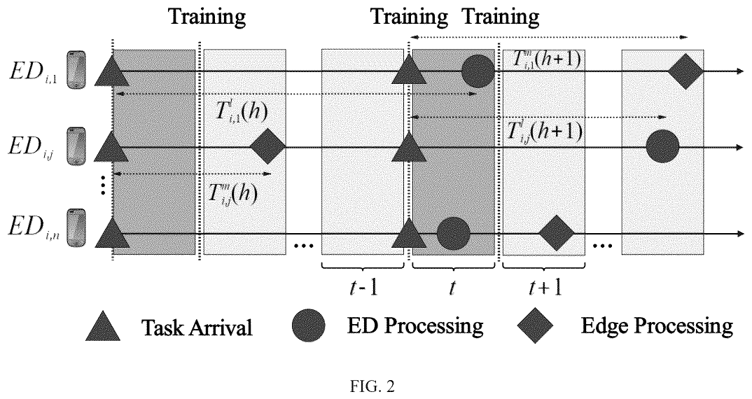

In the proposed system, we adopt a discrete-time running mode, which contains H time-slots with the same span, where h=1, 2, . . . , H. At the beginning of h, ED_{i,j} generates a task, denoted by Task_{i,j} (h)=(D_{i,j} (h), C_{i,j} (h), T_{d}), where D_{i,j} (h) indicates the data volume, C_{i,j} (h) indicates the required computational resources, and T_{d} indicates the maximum tolerable delay. If a task cannot be completed within maximum tolerable delay and available power, it will be determined to be failed. Specifically, the tasks generated by ED_{i,j} will be placed in its buffer queue, and the tasks that first enter the queue will be completed before subsequently arriving tasks can be executed. Moreover, tasks can be processed locally or offloaded to the MEC server for execution. Furthermore, as shown in FIG. 2, we divide each time-slot into T sub-slots for fine-grained model training, where t=1, 2, . . . , T, aiming to avoid excessive delays or task failures caused by inappropriate coarse-grained decisions. When there are more sub-slots, the waiting time for the tasks on the buffer queue might be reduced with better policies, but it will increase the complexity and time of model training. Therefore, the values of T should be properly chosen for different requirements and scenarios.

### Communication Model

When uploading Task_{i,j}(h) to Mᵢ for execution via the AP in Rᵢ, the uplink date rate of ED_{i,j} is defined as

$${r}_{i , j} ( t ) = {w}_{i , j} ( t ) {B}_{i} ( t ) {log}_{2} ( 1 + \frac{{P}_{i , j} ( t ) {g}_{i , j} ( t )}{{σ}^{2} {l}_{i , j} ( t )} ) \qquad ( 1 )$$

where Bᵢ(t) indicates the available upload bandwidth at the sub-slot t, w_{i,j}(t) indicates the proportion of bandwidth allocated to Task_{i,j}(h), P_{i,j}(t) indicates the transmission power of ED_{i,j}, g_{i,j}(t) indicates the channel gain between Mᵢ and ED_{i,j}, σ² indicates the average power of Gaussian white noise, and l_{i,j}(t) indicates the distance between Mᵢ and ED_{i,j}.

Thus, the delay of uploading Task_{i,j}(h) is defined as

$${T}_{i , j}^{tr} ( h ) = \frac{{D}_{i , j} ( h )}{{r}_{i , j} ( t )} \qquad ( 2 )$$

Accordingly, the energy consumption of uploading Task_{i,j}(h) is defined as

$${E}_{i , j}^{tr} ( h ) = {P}_{i , j} ( t ) {T}_{i , j}^{tr} ( t ) \qquad ( 3 )$$

Since the results of executing tasks are much smaller than the data volume uploaded by tasks, the delay and energy consumption of downloading results from Mᵢ to ED_{i,j} can be commonly neglectable.

### Computation Modeli

In the proposed model, all EDs and MEC servers can offer computing services, and thus we consider the local and edge computing modes as follows.

### Local Computing Mode

When a task is executed on an ED, the delay and energy consumption of executing the task are defined as

$${T}_{i , j}^{l} ( h ) = \frac{{C}_{i , j} ( h )}{{f}_{i , j}} \qquad ( 4 )$$

$${E}_{i , j}^{l} ( h ) = {kC}_{i , j} ( h ) {f}_{i , j}^{2} \qquad ( 5 )$$

where f_{i,j} indicates the computing capability (i.e., CPU frequency) of ED_{i,j} and k is the capacitance coefficient.

### Edge Computing Mode

When offloading a task to the MEC server for execution, the delay and energy consumption of executing the task are defined as

$${T}_{i , j}^{m} ( h ) = \frac{{C}_{i , j} ( h )}{{β}_{i , j} ( t ) {F}_{i} ( t )} \qquad ( 6 )$$

$${E}_{i , j}^{m} ( h ) = {P}_{m} {T}_{i , j}^{m} ( h ) \qquad ( 7 )$$

where β_{i,j}(t) indicates the proportion of computational resources allocated by Mᵢ to Task_{i,j}(h), Fᵢ(t) indicates the available computational resources of Mᵢ, and Pₘ indicates the computing power of Mᵢ.

### Energy Harvesting Model

In the proposed system, all EDs are equipped with rechargeable batteries with a maximum capacity of bₘₐₓ. At the beginning of t, the battery power of ED_{i,j} is b_{i,j}(t). During the process of harvesting energy, ED_{i,j} receives energy through WPT and deposits it into the battery in the form of energy packets, and the amount of harvested energy by an ED during t is denoted as eₜ, which can be used to execute tasks locally or offload tasks to Mᵢ for execution. Specifically, for different system states during t, we consider different situations of power variations on ED_{i,j} as follows.
If the task buffer queue of ED_{i,j} is empty, there is only charging but no energy consumption. Thus, at the beginning of t+1, the battery power of ED_{i,j} is

$${b}_{i , j} ( t + 1 ) = min ( {b}_{i , j} ( t ) + {e}_{t} , {b}_{max} ) \qquad ( 8 )$$

If Task_{i,j}(h) is completed on ED_{i,j}, the battery power of ED_{i,j} at the beginning of t+1 is

$${b}_{i , j} ( t + 1 ) = min \{ max \{ {b}_{i , j} ( t ) + {e}_{t} - {E}_{i , j}^{l} ( h ) , 0 \} , {b}_{max} \} \qquad ( 9 )$$

If Task_{i,j}(h) fails on ED_{i,j} because T (h) exceeds T_{d} or E_{i,j}^{l}(h) exceeds b_{i,j}(t), the battery power of ED_{i,j} at the beginning of t+1 is

$${b}_{i , j} ( t + 1 ) = min \{ max \{ {b}_{i , j} ( t ) + {e}_{t} - {E}_{i , j}^{l} ( h ) , 0 \} , {b}_{max} \} \qquad ( 10 )$$

If Task_{i,j}(h) is offloaded to Mᵢ and be completed successfully, the battery power of ED_{i,j} at the beginning of t+1 is

$${b}_{i , j} ( t + 1 ) = min \{ max \{ {b}_{i , j} ( t ) + {e}_{t} - {E}_{i , j}^{tr} ( h ) - {E}_{i , j}^{m} ( h ) , 0 \} , {b}_{max} \} \qquad ( 11 )$$

If Task_{i,j}(h) fails because T_{i,j}^{tr}(h) exceeds T_{d} or E_{i,j}^{tr}(h) exceeds b_{i,j}(t), the battery power of ED_{i,j} at the beginning of t+1 is

$${b}_{i , j} ( t + 1 ) = min \{ max \{ {b}_{i , j} ( t ) + {e}_{t} - \frac{\frac{h}{T}}{{T}_{i , j}^{tr} ( h )} {E}_{i , j}^{tr} ( h ) , 0 \} , {b}_{max} \} \qquad ( 12 )$$

If Task_{i,j}(h) fails on Mᵢ because T_{i,j}^{m}(h) exceeds T_{d} or E_{i,j}^{m}(h) exceeds b_{i,j}(t), the battery power of ED_{i,j} at the beginning of t+1 is

$${b}_{i , j} ( t + 1 ) = min \{ max \{ {b}_{i , j} ( t ) + {e}_{t} - {E}_{i , j}^{tr} ( h ) - \frac{\frac{h}{T} - {T}_{i , j}^{tr} ( h )}{{T}_{i , j}^{m} ( h )} {E}_{i , j}^{tr} ( h ) , 0 \} , {b}_{max} \} \qquad ( 13 )$$

### Formulation of Optimization Objective

Based on the above system models, the delay and energy consumption of executing a task with different offloading decisions are respectively defined as

$${T}_{i , j} ( h ) = ( 1 - {α}_{i , j} ( t ) ) {T}_{i , j}^{l} ( h ) + {α}_{i , j} ( t ) ( {T}_{i , j}^{tr} ( h ) + {T}_{i , j}^{m} ( h ) ) \qquad ( 14 )$$

$${E}_{i , j} ( h ) = ( 1 - {α}_{i , j} ( t ) ) {E}_{i , j}^{l} ( h ) + {α}_{i , j} ( t ) ( {E}_{i , j}^{tr} ( h ) + {E}_{i , j}^{m} ( h ) ) \qquad ( 15 )$$

where α_{i,j}(t)∈{0, 1} is the offloading decision, which indicates that a task will be executed locally or offloaded to the MEC server for execution.

To minimize the delay and energy consumption of executing tasks, the optimization objective is formulated as

$$( P 1 ) {min}_{α , β , w} {\sum }_{j = 1}^{n} {\sum }_{h = 0}^{H} {q}_{i , t} {T}_{i , j} ( h ) + {q}_{i , e} {E}_{i , j} ( h ) \qquad ( 16 )$$

$$s . t . C 1 : {α}_{i , j} ( t ) ∈ \{ 0 , 1 \}$$

$$C 2 : {T}_{i , j} ( h ) \leq {T}_{d}$$

$$C 3 : {E}_{i , j} ( h ) \leq {b}_{i , j} ( t )$$

$$C 4 : {\sum }_{i = 1}^{N} {α}_{i , j} ( t ) {w}_{i , j} ( t ) = 1$$

$$C 5 : {\sum }_{i = 1}^{N} {α}_{i , j} ( t ) {β}_{i , j} ( t ) = 1$$

where q_{i,t} and q_{i,e} indicate the weights of delay and energy consumption, respectively. C1 indicates that a task can only be executed locally or offloaded to the MEC server for execution. C2 indicates that the delay of executing a task cannot exceed the maximum tolerable delay. C3 indicates that the energy consumption of executing a task cannot exceed the available battery power of an ED. C4 indicates that the sum of the proportion of bandwidth allocated for uploading tasks should be 1. C5 indicates that the sum of the proportion of the computational resources allocated for executing offloaded tasks should be 1.

To address the above optimization problem, we propose a novel Personalized Federated deep Reinforcement learning based computation Offloading and resource Allocation method (PFR-OA). First, for single-edge scenarios, we design an improved twin-delayed DRL-based algorithm to approximate the optimal policy. Next, for multi-edge scenarios, we develop a new distributed training framework based on personalized FL to further enhance the model adaptiveness and training efficiency.

### I) Improved Twin-Delayed DRL for Computation Offloading and Resource Allocation

P1 can be transformed into a classic problem of online budgeted maximum coverage, which has been proven to be NP-hard. In this problem, the element eᵢ is selected at each step that contains costs and values, and thus all the selected elements during the whole process can be denoted as the set E={e₁, e₂, . . . , eₙ}. The optimization objective of this problem is to find a set E′⊆E that can maximize the total values while the total costs do not exceed the budget. For P1, we regard the task to be processed at each sub-slot as an element in E, the computational resources allocated to the task as costs, and the rewards of completing the task as values. The objective is to find a set {α′, β′, w′}⊆{α, β, w} (i.e., an optimized policy of computation offloading and resource allocation) that can maximize the rewards without exceeding the constraints on available bandwidth and computational resource, which is the optimization objective of P1. Therefore, P1 is an NP-hard problem. To solve this complicated problem, we model it as a Markov Decision Process (MDP) and propose a new DRL-based solution.

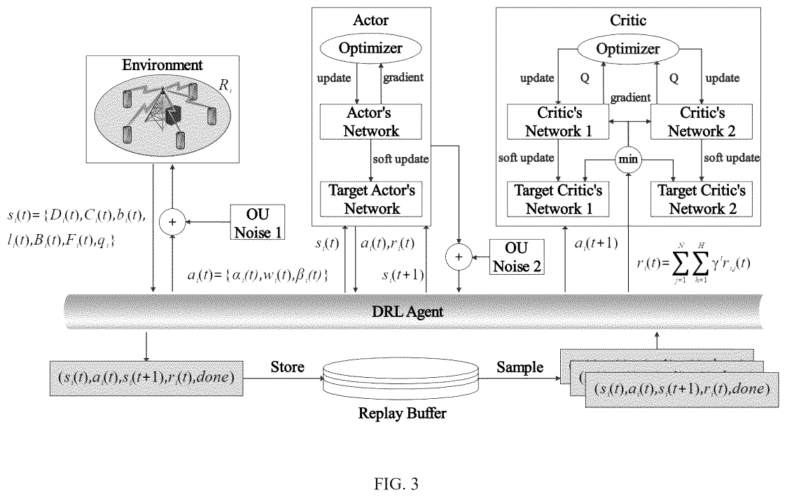

Specifically, we design an improved twin-delayed DRL-based algorithm to address P1 for single-edge scenarios, aiming to minimize the delay and energy consumption of executing tasks. Based on an actor-critic framework, the classic twin-delayed DRL combines deep deterministic policy gradient and dual Q-learning, which performs well on many continuous-control problems. However, the classic twin-delayed DRL adopts a manner of local updating, which reveals the negative impact on global model convergence during distributed training. Moreover, the high frequency of error updates to the actor's network results in serious action dispersion. To address these issues, the proposed improved twin-delayed DRL-based algorithm lessens the unreasonable update frequency of the actor's network by introducing a new proximal term, which attenuates the dispersion of local updating and reduces the variance of action-value estimation, therefore generating better policies. As shown in FIG. 3, the DRL agent selects actions under different states by interacting with the single-edge environment and continuously optimizes the policies of computation offloading and resource allocation referring to the reward signals from the environment. Accordingly, the state space, action space, and reward function for DRL are defined as follows.
State space: At sub-slot t, the system state is defined as

$${s}_{i} ( t ) = \{ {D}_{i} ( t ) , {C}_{i} ( t ) , {b}_{i} ( t ) , {l}_{i} ( t ) , {B}_{i} ( t ) , {F}_{i} ( t ) , {q}_{i} \} \qquad ( 17 )$$

where Dᵢ(t)={D_{i,j}(t), j∈N} indicates the set of data volumes for all tasks, Cᵢ(t)={C_{i,j}(t), j∈N} indicates the set of required computational resources for all tasks, bᵢ(t)={b_{i,j}(t), j∈N} indicates the set of battery power for all EDs, lᵢ(t)={l_{i,j}(t), j∈N} indicates the set of distances between and all EDs, Bᵢ(t) and Fᵢ(t) indicate the available bandwidth and computational resources of Ali, respectively, and qᵢ={q_{i,t}, q_{i,e}, q_{i,p}} indicates the personalized demands for delay, energy consumption, and task success rate.
Action space: At sub-slot t, the DRL agent makes an action of computation offloading and resource allocation based on the current system state, which is defined as

$${a}_{i} ( t ) = \{ {α}_{i} ( t ) , {w}_{i} ( t ) , {β}_{i} ( t ) \} \qquad ( 18 )$$

where αᵢ(t) indicates the set of offloading decisions for all tasks, and wᵢ(t) and βᵢ(t) indicate the sets of the proportion of bandwidth and computational resources allocated to all tasks, respectively.
Reward function: The optimization objective of P1 is to minimize the weighted sum of delay and energy consumption. Thus, at sub-slot t, the instant reward of processing a task is defined as

$${r}_{i , j} ( t ) = \{ \begin{matrix}- ( {q}_{i , t} {T}_{i , j} ( h ) + {q}_{i , e} {E}_{i , j} ( h ) ) , & Succeed \\ - {q}_{i , p} , & Unsatisfy C 2 \\ - {q}_{i , p} , & Unsatisfy C 3\end{matrix} \qquad ( 19 )$$

If a task can be successfully completed, the instant reward will be the opposite of the weighted sum of delay and energy consumption. If C2 or C3 cannot be satisfied, the instant reward will be q_{i,p}, which is used as the penalty for failing to complete the task. Therefore, the long-term reward is defined as

$${r}_{i} ( t ) = {\sum }_{j = 1}^{N} {\sum }_{h = 1}^{H} {γ}^{t} {r}_{i , j} ( t ) \qquad ( 20 )$$

where γ^{t} is the discount factor.

The main steps of the proposed improved twin-delayed DRL-based computation offloading and resource allocation algorithm are given in Algorithm 1. First, the actor's network μᵢ and two critic's networks Q_{i,1} and Q_{i,2} are initialized, and the target actor's network μᵢ′ and two target critic's networks Q_{i,1}′ and Q_{i,2}′ are initialized accordingly (Line 1). To address the Q-value overestimation issue in classic actor-critic-based DRL, we introduce two critic's networks that separate action selection and Q-value update, aiming to improve the training stability. Next, we initialize the number of training epoch P, the number of time-slots H, the number of sub-slots T, the update frequencies of FL fₚ and the actor's network fₐ, the replay buffer Gᵢ, the batch size N and the learning rate τ (Line 1). For each training epoch, when it comes to the round of FL update, μᵢ(s|θ^{μ}^{ᵢ}), Q_{i,1}(s, a|θ^{Q}^{_{i,1}}), and Q_{i,2}(s, a|θ^{Q}^{_{i,2}}) are uploaded to the C-BS (Line 4). Next, Algorithm 2 is called to obtain aggregated models Q_{f,1}(s, a|θ^{Q}^{_{f,1}}), Q_{f,2}(s, a|θ^{Q}^{_{f,2}}), and μ_{f}(s|θ^{μ}^{_{f}}), which are used to replace local models by soft update (Lines 5˜6). For each sub-slot, the state sᵢ(t) is first input to μᵢ to obtain an action of computation offloading and resource allocation aᵢ(t) and execute this action in the environment, which will feedback the instant reward and the next state sᵢ(t+1) based on execution results (Lines 10˜11). Next, the state-transition process is stored in Gᵢ, where N samples are randomly selected to train network parameters, and then the target actor's network is used to get the next action (Lines 12˜14).

Algorithm 1: Improved twin-delayed DRL for computation offloading and resource
allocation

| 1 | Initialize: μᵢ(s\|θ^{μ}), Q_{i,1}(s, a\|θ^{Q}^{₁}), Q_{i,2}′(s, a\|θ^{Q}^{₂}′), μᵢ′, Q_{i,1}′, Q_{i,2}′, P, H, T, fp, Gᵢ, N, | | |
|---|---|---|---|
| | and τ. | | |
| 2 | for epoch = 0, 1, 2, ... , P do | | |
| 3 | \| | if epoch % fₚ = = 0 then | |
| 4 | \| | \| | Upload Q_{i,1}(s, a\|θ^{Q}^{_{i,1}}), Q_{i,2}(s, a\|θ^{Q}^{_{i,2}}), and μᵢ(s\|θ^{μ}^{ᵢ}) to the C-BS; |
| 5 | \| | \| | Call Algorithm 2 to obtain Q_{f,1}(s, a\|θ^{Q}^{_{f,1}}), Q_{f,2}(s, a\|θ^{Q}^{_{f,2}}), and μ_{f}(s\|θ^{μ}^{_{f}}); |
| 6 | \| | \| | Conduct soft update: Q_{i,1}(s, a\|θ^{Q}^{_{i,1}}) = |
| | | | f_{q}Q_{f1}(s, a\|θ^{Q}^{_{i,1}}) + (1 − f_{q}) Q_{i,1}(s, a\|θ^{Q}^{_{i,1}}), |
| | | | Q_{i,2}(s, a\|θ^{Q}^{_{i,2}}) = f_{q}Q_{f,2}(s, a\|θ^{Q}^{_{f,2}}) + |
| | | | (1 - f_{q})Q_{i,2}(s, a\|θ^{Q}_{i,2}), and μᵢ(s\|θ^{μ}^{ᵢ}) = |
| | | | f_{q}μ_{f}(s\|θ^{μ}_{f}) + (1 - f_{q})μᵢ(s\|θ^{μ}ᵢ); |
| 7 | \| | end | |
| 8 | \| | Receive the initial state s₀ = envᵢ · reset(); | |
| 9 | \| | for t = 0, 1, 2, ... , H * T do | |
| 10 | \| | \| | Select the action aₜ, where aᵢ(t) = |
| | | | μᵢ(s(t)\|θ^{μ}^{ᵢ}) + ε₁, ε₂ ~ clip(N (0, σ₁), −c, c); |
| 11 | \| | \| | Execute aᵢ(t) and receive rᵢ(t) and the next state sᵢ(t + 1), where |
| | | | rᵢ(t), sᵢ(t + 1) = envᵢ · step(aᵢ(t)); |
| 12 | \| | \| | Store the state-transition process in Gᵢ: |
| | | | Gᵢ · push(s(t), a(t), r(t), s(t + 1), done); |
| 13 | \| | \| | Randomly select N samples from Gᵢ: |
| | | | N * (sₜ, aₜ, rₜ, sₜ₊₁) = Gᵢ · Sample(N); |
| 14 | \| | \| | Use target actor’s network to get the next action by Eq. (21); |
| 15 | \| | \| | Calculate target Q-value γ_{target} by Eq. (22); |
| 16 | \| | \| | Update critic’s network by Eq. (23); |
| 17 | \| | \| | if epoch % fₐ = = 0 then |
| 18 | \| | \| | Update actor’s network: ∇_{θ}_{^{μ}}ᵢ J(θ^{μ}^{ᵢ}) = |
| | | | (N⁻¹ Σ₁^{N} ∇ₐ₍ₜ₎ Q_{i,1} (s(t), a(t)\|a=μᵢ_{_{θ}}_{^{μ}}ᵢ; |
| | | | ${∇}_{{θ}^{{μ}_{i}}} {μ}_{{θ}^{{μ}_{i}}} ( s ( t ) ) ) + \frac{{λ}_{{μ}_{i}}}{2} {‖ {θ}^{{μ}_{i}} - {θ}^{{μ}_{f}} ‖}^{2} ;$ |
| 19 | \| | \| | Update target actor’s and critic’s networks: |
| | | | θ^{Q}^{_{i,z}}′ ← pθ^{Q}^{_{i,z}} + (1 − ρ)θ^{Q}^{_{i,z}}′, |
| | | | θ_{μ}_{ᵢ}′ ← pθ^{μ}^{ᵢ} + (1 − ρ)θ^{μ}^{ᵢ}; |
| 20 | \| | \| | end |

| | | |
|---|---|---|
| 21 | \| | end |

| | |
|---|---|
| 22 | end |

Specifically, the proposed algorithm uses the critic's network to fit Qᵢ(s(t), a(t)), which can accurately reflect the Q-values of each action. Meanwhile, we use the actor's network to fit the mapping between s(t) and a(t), and thus the DRL agent can take proper actions at different states and maximize the long-term reward. We introduce the Gaussian noise in the target actor's network to obtain a(t+1), and this process is defined as

$${a}_{i} ( t + 1 ) = {μ}_{i} ( s ( t + 1 ) \vert {θ}^{{μ}_{i}^{′}} ) + {ε}_{2} , {ε}_{2} ∼ clip ( N ( 0 , {σ}_{2} ) , - c , c ) \qquad ( 21 )$$

where the actor's network is endowed with sufficient exploration of selecting target actions by adding noise.

Next, the target Q-value is calculated by considering the current reward and comparing two critic's networks (Line 15), which is defined as

$${y}_{target} ← r ( t ) + γ {min}_{z = 1 , 2} {Q}_{i , z} ( s ( t + 1 ) , a ( t + 1 ) \vert {θ}^{{Q}_{i , z}^{′}} ) \qquad ( 22 )$$

Next, the critic's network is updated by the loss back-propagated of the difference between y_{target} and the current Q-value (Line 16). Due to the variable demands on QoS and system overheads among different edge environments, we design a proximal term to replace the original loss function that only tends to minimize the difference in local Q-values, which speeds up the convergence of the FL-based training framework in Algorithm 2 and reduces the negative impact of local updates on global model convergence during distributed training. The update process is defined as

$${θ}^{{Q}_{i , z}} ← arg {min}_{{θ}_{i , z}} ( {N}^{- 1} \sum {( {y}_{target} - {Q}_{i , z} ( s ( t ) , a ( t ) \vert {θ}^{{Q}_{i , z}} ) )}^{2} ) + \frac{{λ}_{{Q}_{i , z}}}{2} {‖ {θ}^{{Q}_{i , z}} - {θ}^{{Q}_{f , z}} ‖}^{2} . \qquad ( 23 )$$

Finally, to reduce the improper update of the actor's network, we design a soft updating mechanism, which makes the update frequency of the actor's network less than the critic's network and thus avoids the action dispersion caused by the high frequency of error updates (Lines 17˜20). With this design, the variance of action-value estimation can be effectively reduced, thus generating better policies of computation offloading and resource allocation.

### II) Personalized FL-Based Training for DRL

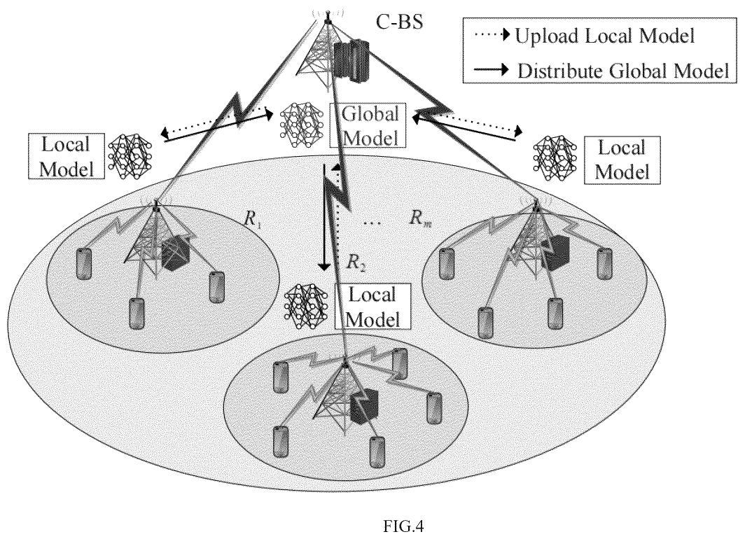

In classic centralized training manners, all the information about EDs may need to be uploaded to a central server to train a DRL-based decision-making model of computation offloading and resource allocation. Such manners can achieve good model performance with rich training samples, but it is prone to severe network congestion and the potential risk of privacy leakage. As an emerging distributed training framework, the multi-agent DRL allows each agent to be trained independently, but the performance of local models will be seriously limited if some agents lack training samples. In contrast, the FRL can solve this issue by implementing a collaborative model training on data silos with the original purpose of privacy. However, different smart communities usually have personalized demands on QoS and system overheads. In this case, the classic FRL with the average aggregation of model parameters cannot make an effective response. To solve these issues, we design a new personalized FL-based training framework to further improve the adaptiveness and training efficiency of the DRL-based computation offloading and resource allocation model for different environments. The proposed personalized FRL-based training framework is illustrated in FIG. 4, whose main steps are given in Algorithm 2.

First, we initialize the federated actor's network μ_{f}, two federated critic's networks Q_{f,1} and Q_{f,2}, the number of edges participating in FRL training K (K≤m), and the communication rounds for federated aggregation P_{f} (Line 1). In each communication round, we introduce a new proximal term to attenuate the dispersion of local updates, because different smart communities commonly own personalized demands on QoS and system overheads. Specifically, the proximal term is added to the local training loss by calling Algorithm 1, allowing faster convergence to the global optimum. The process is defined as

$${θ}_{i}^{t + 1} \approx {min}_{{θ}_{i}^{t}} {h}_{i}^{t} ( {θ}_{i}^{t} ; {θ}_{f}^{r} ) = L ( {θ}_{i}^{t} ) + \frac{{λ}_{{θ}_{i}}}{2} {‖ {θ}_{i}^{t} - {θ}_{f}^{r} ‖}^{2} \qquad ( 24 )$$

where λ_{θ}_{ᵢ}={λ_{Q}_{_{i,1}}, λ_{Q}_{_{i,2}}, λ_{μ}_{ᵢ}} is the parameter set of the proximal term. We use an adaptive tuning of λ_{θ}_{ᵢ}, indicating the loss changes of local models, to solve the issue of model heterogeneity. This design limits the iterative trajectories of local agents to avoid the training dispersion caused by the deviation of local models.

Algorithm 2: The proposed personalized
FL-based training for DRL

| 1 | | | | Initialize: μ_{f}, Q_{f,1}, Q_{f,2}, K, and P_{f}. |
|---|---|---|---|---|
| 2 | | | | for r = 1, 2, ..., P_{f} do |
| 3 | \| | | | for i = 1, 2, ..., m do |
| 4 | \| | \| | | Call Algorithm 1 to obtain μᵢ(s\|θ^{μ}^{ᵢ}), |
| | \| | \| | | Q_{i,1}(s, a\|θ^{Q}^{_{i,1}}), and Q_{i,2}(s, a\|θ^{Q}^{_{i,2}}) and |
| | \| | \| | | upload them to the C-BS; |
| | \| | \| | | |
| 5 | \| | | | end |
| 6 | \| | Sort DRL models in R by ascending order of training loss: R = | | |
| | \| | | | env.sort(R); |
| 7 | \| | | | for k = 1, 2, ..., K do |
| 8 | \| | \| | | if random.uniform(0, 1) < ε then |
| 9 | \| | \| | \| | Select one of the first K models from the sorted R to |
| | \| | \| | \| | Zᵣ; |
| 10 | \| | \| | | else |
| 11 | \| | \| | \| | Randomly select a model from R to Zᵣ; |

| | | | |
|---|---|---|---|
| 12 | \| | \| | end |

| | | |
|---|---|---|
| 13 | \| | end |

| | | |
|---|---|---|
| 14 | \| | Conduct federated aggregation of K DRL models in Zᵣ |

| | |
|---|---|
| \| | according to Eq. (25); |

| | | |
|---|---|---|
| 15 | \| | Distribute the aggregated models to Rᵢ(Rᵢ ∈ R); |

| | |
|---|---|
| 16 | end |

In each communication round, each DRL model in Rᵢ(Rᵢ∈R) uploads the actor's network μᵢ(s|θ^{μ}^{ᵢ}) and two critic's networks Q_{i,1}(s, a|θ^{Q}^{_{i,1}}), and Q_{i,2}(s, a|θ^{Q}^{_{i,2}}) to the C-BS (Lines 3˜5). Next, we sort DRL models by ascending order of their training loss (Line 6), and then we design a partial-greedy based participant selection mechanism, where the C-BS uses e-greedy to select some DRL models for federated aggregation (Lines 7˜14). To ensure the selected models with both high performance and generalization, we select the DRL model with the lowest training loss by the probability of ε and randomly select DRL models in the other cases. Compared to the classic FRL that aggregates the models of all participants, the proposed mechanism reduces the training complexity while enabling the training process with sufficient exploration. The process of federated aggregation is defined as

$${Q}_{f , 1} ( s , a \vert {θ}^{{Q}_{f , 1}} ) = \frac{1}{K} {\sum }_{i ∈ {Z}_{r}} {Q}_{i , 1} ( s , a \vert {θ}^{{Q}_{i , 1}} ) , \qquad ( 25 )$$

$${Q}_{f , 2} ( s , a \vert {θ}^{{Q}_{f , 2}} ) = \frac{1}{K} {\sum }_{i ∈ {Z}_{r}} {Q}_{i , 2} ( s , a \vert {θ}^{{Q}_{i , 2}} ) ,$$

$${μ}_{f} ( s \vert {θ}^{{μ}_{f}} ) = \frac{1}{K} {\sum }_{i ∈ {Z}_{r}} {μ}_{i} ( s \vert {θ}^{{μ}_{i}} ) .$$

Finally, the C-BS distributes the aggregated DRL models to the DRL agents in each Rᵢ(Rᵢ∈R) (Line 15) and waits for the next communication round of FRL training.

### III) Complexity Analysis of PFR-OA

At the sub-slot t, the sizes of state and action spaces in a DRL agent are |sᵢ(t)| and |aᵢ(t)|, respectively, and all m DRL agents own the same network structure. Therefore, the following two parts should be considered when calculating the complexity of the proposed PFR-OA.
Reward calculation: The complexity of calculating rewards for all DRL agents is Yₜ^{R}=O(m·|sᵢ(t)|).
Action selection: The numbers of layers and neurons in the actor's network and two critic's networks are considered when calculating the complexity of selecting actions. For the actor's network, the number of neurons in the layer i is denoted as Uᵢ^{A}, and the number of layers is denoted as M^{A}. Therefore, the complexity of the layer i is O(Uᵢ₋₁^{A}Uᵢ^{A}+Uᵢ^{A}Uᵢ₊₁^{A}), and the complexity of the actor's networks for all DRL agents is Yₜ^{A}=O(m·(|sᵢ(t)|·U₂^{A}+Σᵢ₌₃^{M}^{^{A}}⁻²(Uᵢ₋₁^{A}Uᵢ^{A}+Uᵢ^{A}Uᵢ₊₁^{A})+U_{M}_{^{A}}₋₁^{A}·|aₜ|)). Similarly, the number of neurons in the layer j of the critic's network is denoted as Uⱼ^{C}, and the number of layers is denoted as M^{C}. Thus, the complexity of the layer j of the critic's network is O(Uⱼ₋₁^{C}Uⱼ^{C}+Uⱼ^{C}Uⱼ₊₁^{C}). Since there are two critic's networks with the same structure, the complexity of the critic's networks for all DRL agents is Yₜ^{C}=O(2m·(|s(t)|·U₂^{C}+Σⱼ₌₃^{M}^{^{C}}⁻²(Uⱼ₋₁^{C}Ūⱼ^{C}+Uⱼ^{C}Uⱼ₊₁^{C})+U_{M}_{^{C}}₋₁^{C})). With the above considerations, the complexity of selecting actions for all DRL agents is Yₜ^{AC}=Tₜ^{A}+Tₜ^{C}.

By combining the above two parts, the complexity of a DRL agent is Yₜ=Yₜ^{R}+Yₜ^{AC} at the sub-slot t, and thus the complexity of completely training a DRL agent is O(H·T·Yₜ). Considering the FRL training process, the complexity of the proposed PFR-OA is O(P_{f}·H·T·Yₜ).
we evaluate the proposed PFR-OA through extensive comparison experiments on both simulation and testbed environments.

### (1) Experiment Setup

### Datasets and Parameter Settings

We refer to the architecture of the real-world edge computing platform (i.e., C-ESP) and adopt its running datasets. The C-ESP builds an edge computing platform covering almost all regions in China, which hosts different types of service providers and records running datasets. Specifically, the datasets come from 2359 edge servers deployed in more than 1,000 locations and 96,209 users with 10,159,851 requests. From the datasets, we can obtain the fuzzy geographic locations of request senders (i.e., users) and receivers (i.e., edge servers) with unique identifiers and the generation time of requests. It is noted that the geographic locations are fuzzy based on IP addresses to protect user privacy. The simulation experiments are conducted on a workstation with an 8-core Intel® Xeon® Sliver 4208 CPU @3.2 GHz, two NVIDIA GeForce RTX 3090 GPUs, and 32 GB of RAM. Based on PyTorch, we implement the proposed system model and PFR-OA. Specifically, the system model is built with three MEC servers, where each MEC server owns computing capability Fᵢ(t) of 20 GHz. Meanwhile, each MEC server is equipped with a BS with bandwidth Bᵢ(t) of 15 MHz, where the EDs within the communication coverage are connected to it via the wireless network. The tasks of EDs are generated with various demands for dynamic multi-edge communities based on the running datasets of C-ESP. Moreover, a complete training epoch contains 20 time-slots and each time-slot contains 4 sub-slots. As for the other parameters in the proposed model, we set T_{d}=1.5 s, D_{i,j}(h)∈[0.5, 1.5] MB, C_{i,j}(h)∈[1, 1.2] GHz, P_{i,j}(t)∈[100, 400]W, f_{i,j}∈[1, 1.2] GHz, P_{i,j}(t)∈[0.1, 0.4] MB/s, Pₘ=100 W, bₘₐₓ=120 J, eₜ=40 J, k=e⁻²⁶, and σ=e⁻³, respectively. As for the parameters in the proposed PFR-OA, we set γ=0.995, τ=0.0001, fₚ=50, f_{q}=0.3, N=256, ρ=0.1, and fₐ=2, respectively.

### Performance Indications

To comprehensively evaluate the proposed PFR-OA, we use the following performance indicators.
Reward: Sum of instant rewards.
Task success rate: Rate of completed tasks.
Average energy consumption: Average energy consumption of all tasks, considering failed tasks.
Average waiting time: Average waiting time of all tasks, considering failed tasks.

### Benchmark Methods

To verify the superiority of the proposed PFR-OA, we compare it with the following benchmark methods.
MCF-TD3: The model is trained by the average federated aggregation of multiple TD3-based DRL agents.
TD3: The model is trained by the TD3 algorithm without multi-edge collaboration.
DDPG: The model is trained by the DDPG algorithm without multi-edge collaboration.
DQN: The model is trained by the DQN algorithm without multi-edge collaboration, where the continuous action space is discretized.
Greedy: Tasks tend to be executed on EDs if the maximum tolerable delay can be satisfied.
Edge: All tasks are offloaded to the MEC server for execution, where resources are evenly distributed.
Local: All tasks are executed on EDs.

### (2) Experiment Results and Analysis

### Hyperparameter Tuning

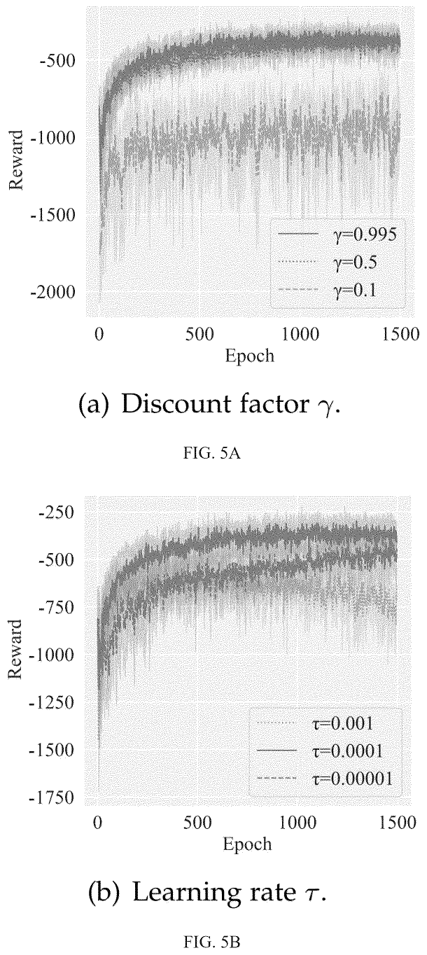

We analyze the impact of different hyperparameters (including the reward discount factor γ and learning rate τ) on the performance of the proposed PFR-OA. As shown in FIG. 5A, when γ is small (e.g., 0.1), the PFR-OA focuses on the instant reward and thus adopts a short-sighted policy. However, it is commonly expected that the current decision can make a good balance between the instant and future rewards. As γ grows, the long-term rewards are fully considered in the current decision, thus improving model performance. It should be noted that γ=1 indicates that the infinitely far future rewards will be considered in the current decision, which is unreasonable in practice. As shown in FIG. 5B, the proposed PFR-OA can quickly converge to a steady status with different values of τ. As τ increases, there occurs a more significant influence of new environments on policies, accompanied by more pronounced model oscillations. Conversely, as τ decreases, the model becomes less exploratory, exhibiting slower convergence, and may not converge to the optimum. Based on the above hyperparameter tuning and analysis, the PFR-OA achieves excellent performance with γ=0.995 and τ=0.0001, and thus we adopt this setting in the subsequent experiments.

### Convergence Comparison

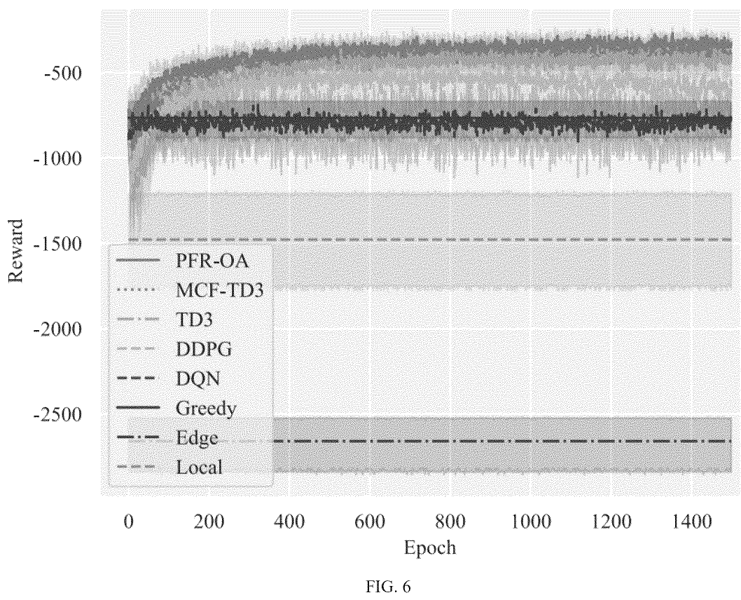

As shown in FIG. 6, we compare the convergence of the different methods. The Greedy, Edge, and Local are single-step decision-making methods, and thus there is no learning and optimization process. Compared to the DRL-based methods, the Greedy, Edge, and Local perform worse. This is because their policies of computation offloading and resource allocation are relatively blind without fully considering system states and task characteristics, resulting in massive failed tasks due to violating the constraints on the maximum tolerable delay or battery power. Compared to the advanced MCF-TD3 that performs best among other DRL-based methods, the proposed PFR-OA converges to better performance faster. This is because the PFR-OA improves the loss function in the classic TD3 by designing a new proximal term while considering personalized demands in multi-edge smart communities.

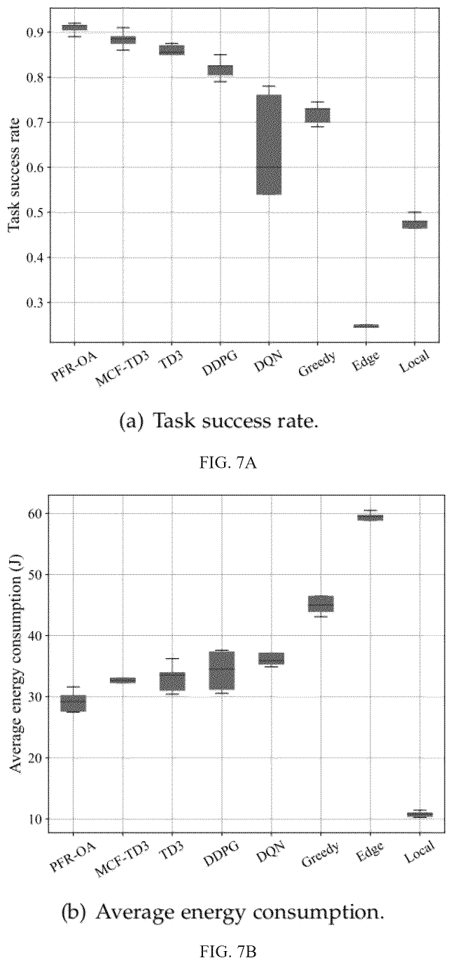

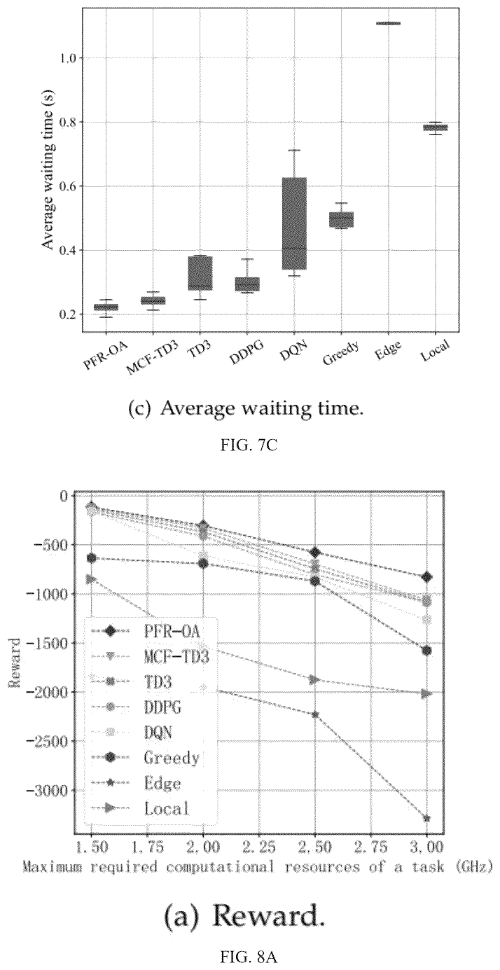

Specifically, as shown in FIG. 7A, we compare the task success rates of different methods after convergence. The PFR-OA can converge to better performance and complete more tasks than other methods under delay and power constraints. Moreover, FIGS. 7B and 7C illustrate the average energy consumption and average waiting time of different methods after convergence. The Local consumes the least energy by executing all tasks on EDs because the power of EDs is much lower than MEC servers. However, limited by the computing capabilities of EDs, more tasks may fail due to exceeding the maximum tolerable delay, also resulting in longer average waiting time. The Edge offloads all tasks to MEC servers for execution, leading to excessive waiting time and energy consumption. Compared to other advanced DRL-based methods, the proposed PFR-OA achieves better performance in terms of task success rate, average energy consumption, and average waiting time with the improved twin-delayed DRL and well-designed personalized FL-based framework.

Performance Comparison with Various Required Computational Resources of Tasks

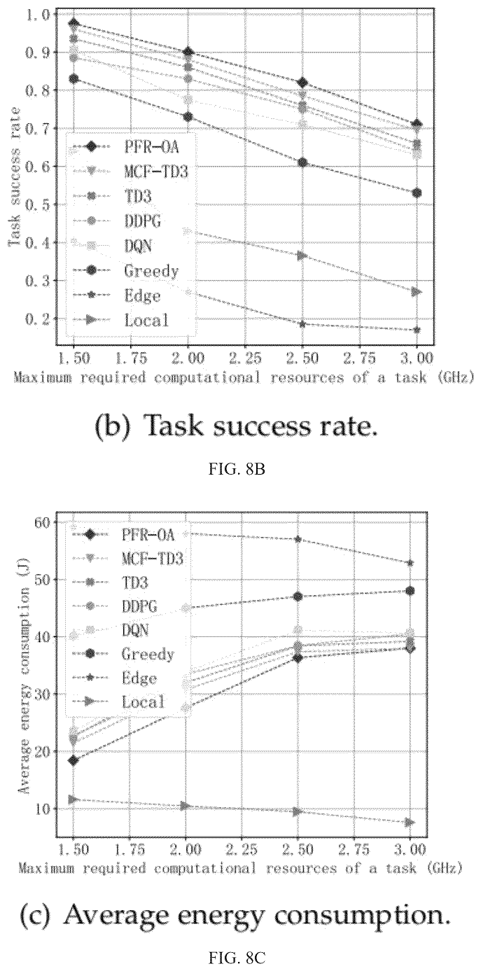

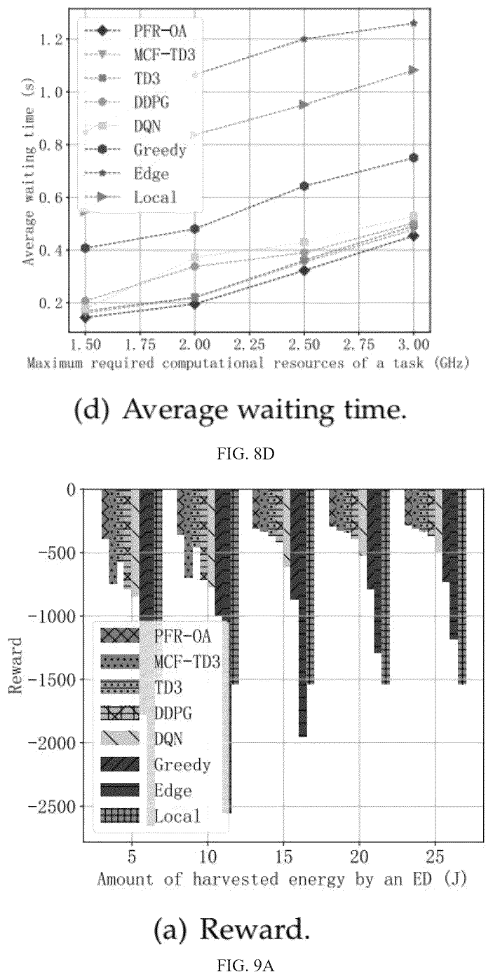

As illustrated in FIG. 8A, we evaluate the overall performance of different methods with various required computational resources of tasks in terms of reward. When tasks require a smaller amount of computational resources, they consume less delay and energy while more tasks can be completed under constraints, leading to higher rewards. As this variable increases, more tasks may fail because they cannot satisfy the delay and energy constraints, causing decreased rewards. Specifically, as shown in FIG. 8B, the proposed PFR-OA can achieve higher task success rates than the advanced MCF-TD3 and TD3 by introducing a personalized FL-based framework. Compared to the DQN, the PFR-OA can better handle the continuous problem of resource allocation and make proper policies according to diverse task characteristics, ensuring more completed tasks. FIGS. 8C and 8D compare different methods in terms of average energy consumption and average waiting time. The Local executes all tasks on EDs, resulting in lower energy consumption.

However, due to the limited computational capabilities of EDs, a lower task success rate happens with the increasing difficulty of executing tasks. The Edge offloads all tasks to MEC servers for execution, leading to higher energy consumption and transmission delay. It is worth noting that the proposed PFR-OA displays better performance than other advanced DRL-based methods regarding task success rate, average energy consumption, and average waiting time.

Performance Comparison with Various Harvested Energies by an ED

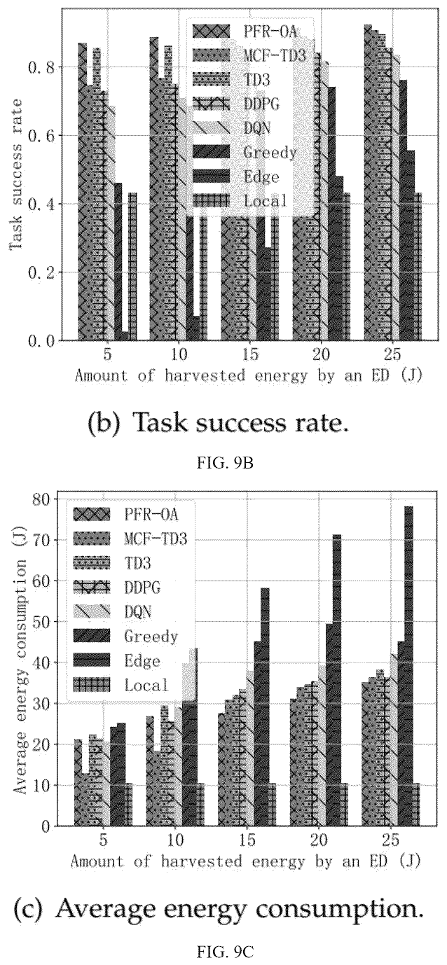

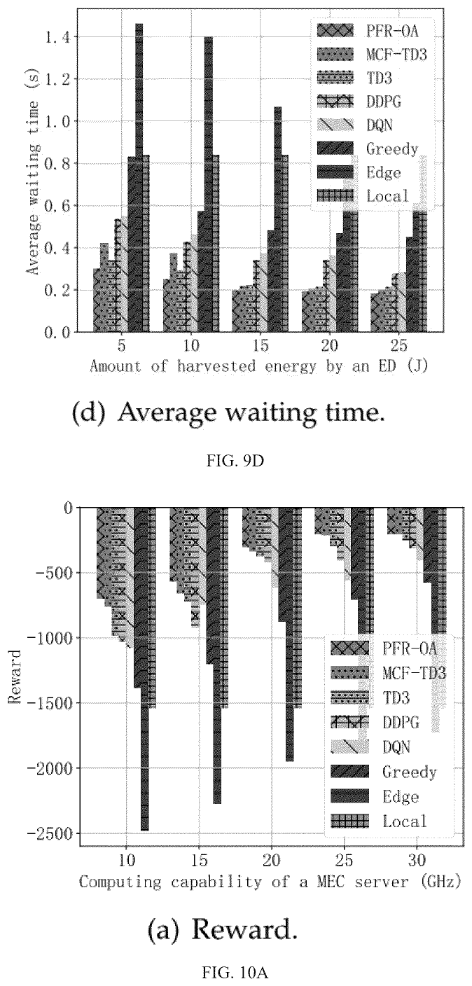

FIGS. 9A-9D compare different methods with various harvested energies by an ED from the perspectives of diverse performance indicators. The performance of the Local does not change as the harvested energies of EDs increase. This is because the setting of the minimum harvested energy can already satisfy the demands of executing tasks on EDs, and thus the growth of this variable does not affect the performance of the Local. It is noted that more tasks can be offloaded to MEC servers for execution with the support of increasing harvested energies. Thus, the Edge reduces the task processing delay but leads to an increase in energy consumption. As for other methods that include the offloading process, the rewards continue to improve as the harvested energies of the EDs rise. This improvement is accompanied by an increase in task success rate and a decrease in task processing delay, thus leading to a decline in the average waiting time. In most cases, compared to other methods, the proposed PFR-OA exhibits better performance in terms of reward, task success rate, average energy consumption (except the Local), and average waiting time. This verifies that the PFR-OA is able to better solve the problem of computation offloading and resource allocation in multiedge environments with personalized demands, considering delay and power constraints.

Performance Comparison with Various Network Bandwidths of a BS

We test the influence of various network bandwidths on the performance of different methods. As shown in Table 2, the changes in network bandwidths do not affect the performance of the Local because it does not contain the offloading process. As the network bandwidth increases, the performance of the Edge enhances most significantly. This is because the Edge offloads all tasks to MEC servers for execution, and thus the increasing network bandwidths can reduce the task transmission delay, also considerably improving reward and task success rate. With the increase in network bandwidths, the performance of different methods tends to stabilize. This is because fewer tasks fail due to exceeding the delay constraint during the offloading process. Since the energy consumption of computation offloading is much higher than the local execution, EDs may not support too many tasks for offloading under the constraint of battery power. In this case, the performance cannot be further improved. It is noted that the proposed PFR-OA outperforms other advanced DRL-based methods regarding different performance indicators, verifying its superiority in handling the complex issue of computation offloading and resource allocation in dynamic multi-edge environments.

TABLE 2
Performance comparison of different methods with various network bandwidths of a BS

| | | | Task success | Average energy | Average waiting |
|---|---|---|---|---|---|
| Scenario | Method | Reward | rate | consumption (J) | time (s) |
| Bᵢ (t) = 5 MHz | PFR-OA | −446.23 | 0.87 | 31.47 | 0.26 |
| | MCF-TD3 | −477.34 | 0.85 | 34.00 | 0.30 |
| | TD3 | −489.75 | 0.83 | 32.51 | 0.32 |
| | DDPG | −522.52 | 0.81 | 35.20 | 0.36 |
| | DQN | −675.71 | 0.77 | 39.15 | 0.39 |
| | Greedy | −940.16 | 0.65 | 45.56 | 0.60 |
| | Edge | −2918.37 | 0.19 | 59.12 | 1.21 |
| | Local | −1535.33 | 0.43 | 10.47 | 0.84 |
| Bᵢ (t) = 15 MHz | PFR-OA | −305.82 | 0.90 | 27.58 | 0.19 |
| | MCF-TD3 | −331.53 | 0.88 | 30.74 | 0.22 |
| | TD3 | −369.24 | 0.86 | 31.96 | 0.22 |
| | DDPG | −414.15 | 0.83 | 33.45 | 0.34 |
| | DQN | −610.26 | 0.78 | 37.93 | 0.37 |
| | Greedy | −871.12 | 0.73 | 45.00 | 0.48 |
| | Edge | −1946.38 | 0.27 | 58.36 | 1.07 |
| | Local | −1535.35 | 0.43 | 10.47 | 0.84 |
| Bᵢ (t) = 25 MHz | PFR-OA | −285.69 | 0.92 | 26.62 | 0.19 |
| | MCF-TD3 | −312.83 | 0.89 | 29.35 | 0.20 |
| | TD3 | −333.45 | 0.89 | 29.00 | 0.20 |
| | DDPG | −374.31 | 0.87 | 30.81 | 0.31 |
| | DQN | −533.62 | 0.83 | 36.63 | 0.35 |
| | Greedy | −680.04 | 0.78 | 42.04 | 0.43 |
| | Edge | −1645.64 | 0.38 | 55.24 | 0.90 |
| | Local | −1535.32 | 0.43 | 10.47 | 0.84 |

Performance Comparison with Various Computing Capabilities of a MEC Server

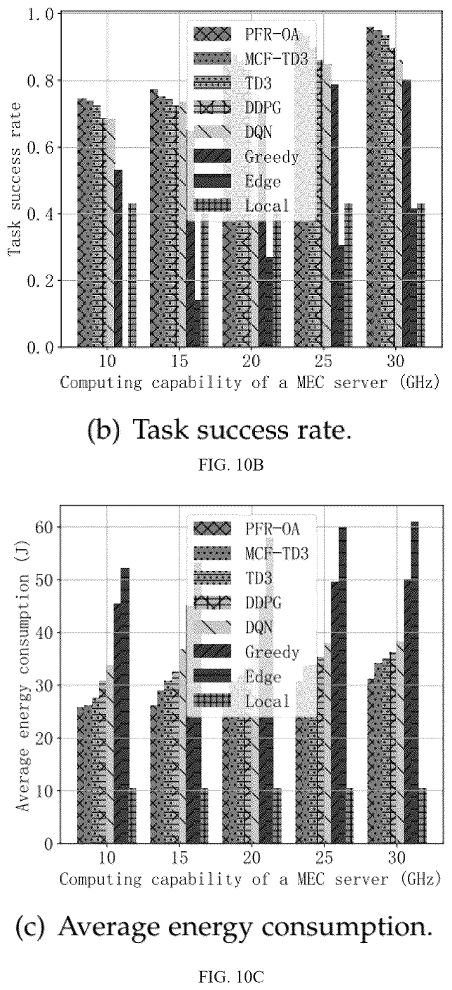

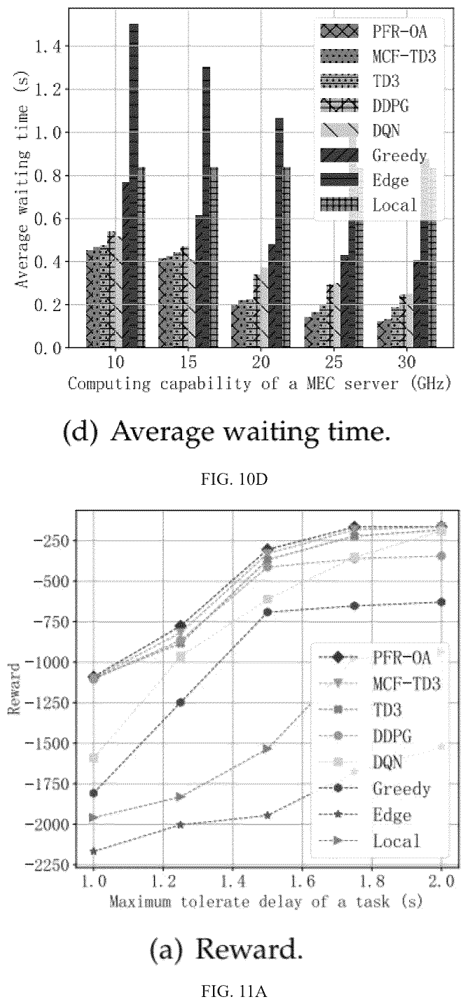

We evaluate the performance of different methods with various computing capabilities of MEC servers. As depicted in FIG. 10A, there is no offloading process in the Local, and thus the increase of computing capabilities of MEC servers does not affect its performance. With the rise of this variable, both the reward and task success rate of all methods exhibit a growing trend. Compared to other advanced DRL-based methods, the proposed PFR-OA performs better because it can effectively ameliorate the negative impact of local updates on model convergence in classic distributed training. As shown in FIG. 10B, the performance of all methods (except the Local) tend to be stable as the computing capabilities of MEC servers rise because fewer offloaded tasks fail due to exceeding the delay constraint.

However, EDs are constrained by battery power and cannot support offloading too many tasks, and thus the performance of these methods cannot be further improved. As shown in FIGS. 10C and 10D, more tasks can be offloaded to MEC servers for execution as their computing capabilities expand. Therefore, the average energy consumption of all methods (except the Local) reveals an increasing tendency. Meanwhile, by offloading tasks to MEC servers, the task execution delay can be lessened, and thus the average waiting time exhibits a decreasing tendency. Among all these methods, the proposed PFR-OA can always keep more excellent overall performance.

Performance Comparison with Various Maximum Tolerable Delays of a Task

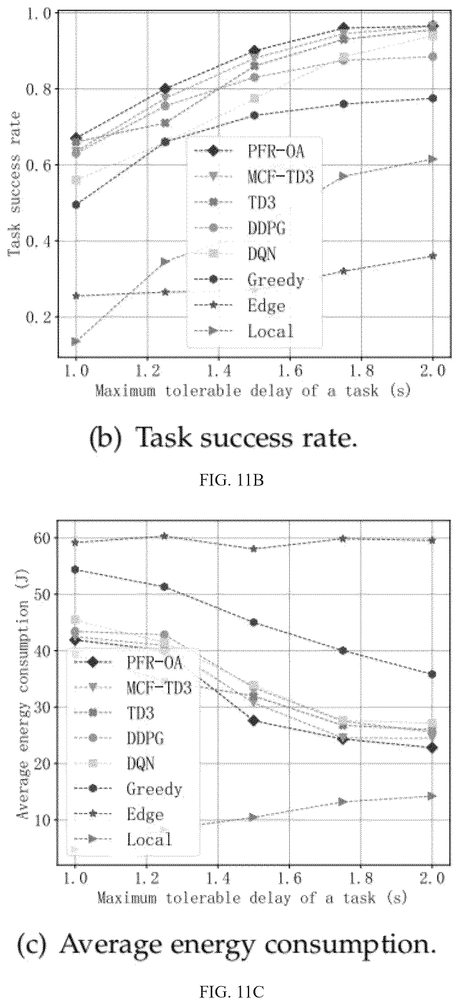

We compare the impact of various maximum tolerable delays on the performance of different methods. As illustrated in FIGS. 11A-11D, the reward and task success rate of all methods rise as the maximum tolerable delay increases because fewer tasks fail due to violating the maximum tolerable delay. However, limited by computing capabilities, EDs may take a long time to execute tasks. Therefore, the average waiting time also increases with the growth of the maximum tolerable delay. Since more tasks can be executed, the average energy consumption of the Local increases. The Edge equally distributes the computational resources of MEC servers, and thus each task receives limited resources, leading to higher delay and energy consumption of executing tasks. The Greedy prioritizes executing tasks on EDs, and thus its performance is comparable to the Local. It is noted that more tasks may tend to be executed locally as the maximum tolerable delay increases, leading to the growing task execution delay. Therefore, the average energy consumption of the Greedy declines but its average waiting time boosts.

Compared to other advanced DRL-based methods, the proposed PFR-OA always achieves better results in terms of all performance indicators. This is because the PFR-OA can optimize the computation offloading and resource allocation process by using an improved twin-delayed DRL and efficiently aggregate models across diverse edge environments by introducing a new personalized FL-based framework. The above experimental results validate the superiority of the proposed PFR-OA.

### (3) Real-world Testbed Validation

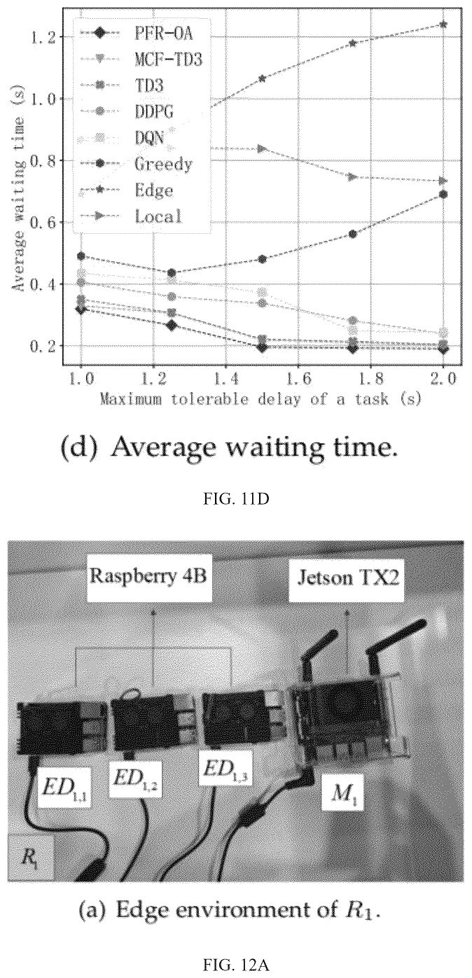

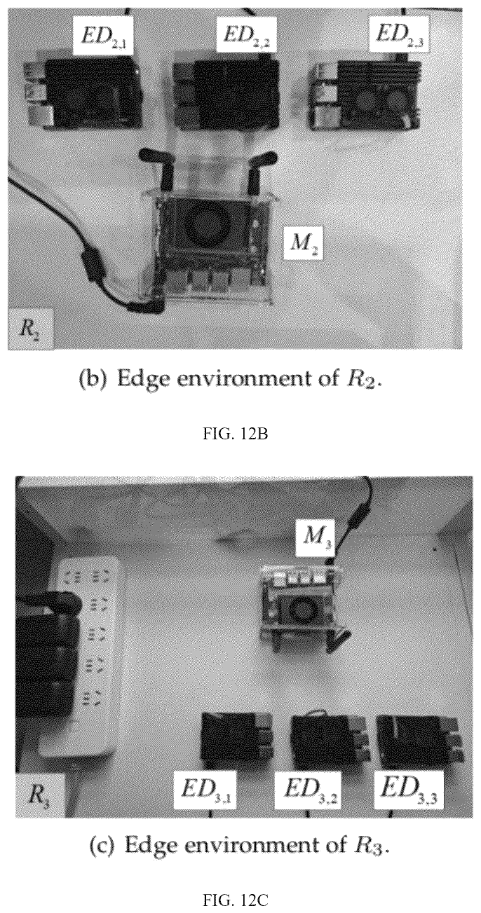

To further verify the practicality and superiority of the proposed PFR-OA, we construct a real-world testbed with hardware devices to evaluate the performance. As shown in FIGS. 12A-12C, the testbed consists of three groups of devices that are located in the lab, where each group contains an MEC server and three EDs. Specifically, each ED is acted by a Raspberry 4B that is equipped with a Broadcom BCM2711 SoC @1.5 GHz, 4 GB of RAM, and a Raspbian GNU/Linux 11 OS, and each MEC server is acted by a Jetson TX2 that is equipped with a 4-core Arm CortexA57 MPCore processor, a 256-core NVIDIA Pascal GPU, 8 GB of RAM, and Ubuntu 18.04.6 LTS.

All these devices are connected to a 5 GHz router where the communication platform is built based on the Flask framework. In the testbed environment, each MEC server owns comparable bandwidth to the simulation environment but its computing capability is different. We adopt image classification as a service instance for computation offloading, where EDs generate tasks of image classification with varying data volumes and resource demands at different time-slots and send offloading requests. If the requests are accepted, the tasks will be uploaded to the corresponding MEC servers for execution. Otherwise, the tasks will be executed locally. Since the data transmission delay might be affected by unstable channels in real-world environments, the errors between the theoretical and actual values of the data transmission time are taken into account. Moreover, we consider the diversity of task attributes and service demands in edge environments of R₁, R₂, and R₃.

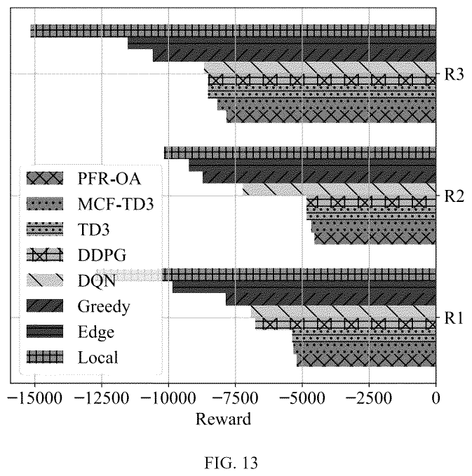

As illustrated in FIG. 13, we compare the performance of the different methods on the real-world testbed. It should be noted that because the hardware devices and tasks in testbed experiments differ from the parameter settings in simulation experiments, the reward values of different methods are not in the same range as simulation results. The Local executes all tasks locally, which cannot handle the cases of task failing when the task execution time exceeds the maximum tolerable delay. The Edge offloads all tasks to MEC servers for execution, leading to the underperformance of some offloaded tasks due to the insufficient allocation of computational resources.

The advanced DRL-based methods can make appropriate offloading decisions based on system states and task attributes. Therefore, the DRL-based methods achieve higher rewards than other heuristics under different edge environments. Among all the DRL-based methods, the proposed PFR-OA reaches the best performance. This is because the PFR-OA considers the demand diversity in different edge environments and improves the efficiency of edge cooperative training through a new personalized FL-based framework, avoiding performance degradation due to local training dispersion. The above results verify the effectiveness of the proposed PFR-OA in real-world scenarios.

In this application, we first formulate the computation offloading and resource allocation in dynamic multi-edge smart community systems with personalized demands as a model-free DRL problem with multiple constraints. Next, we propose a novel PFR-OA that combines an improved twin-delayed DRL-based algorithm and a new personalized FLbased training framework to address the issues of action dispersion and inefficient model updates. Using real-world settings and testbed, extensive experiments demonstrate the effectiveness of the proposed PFR-OA. Compared to the other seven benchmark methods (i.e., MCF-TD3, TD3, DDPG, DQN, Greedy, Edge, and Local), the PFR-OA shows superiority in improving the task success rate, average energy consumption, and average waiting time. Specifically, the PFR-OA outperforms other benchmark methods in different scenarios with various required computational resources of tasks, harvested energies by EDs, network bandwidths of BSs, computing capabilities of MEC servers, and maximum tolerable delays. Notably, we validate the practicality of the PFR-OA on the real-world testbed. When facing heterogeneous devices and diverse demands in different edge environments, the PFR-OA is able to maintain the best performance among all methods.

What is claimed is:

1. A method of joint computation offloading and resource allocation in multi-edge smart communities with personalized federated deep reinforcement learning, comprising: design a new multi-edge smart community system consisting of communication, computing, and energy harvesting models, where the task execution delay and energy consumption are formalized as the optimization objectives under multiple constraints;
for single-edge scenarios, propose an improved twin-delayed DRL-based algorithm; we design a new proximal term to improve the way of only optimizing local Q-value loss function in classic DRL, and reduce the variance of action-value estimation by decreasing the frequency of network updates;
for multi-edge scenarios, develop a novel personalized FL-based training framework for DRL; during the training process, consider the personalized demands of smart communities on QoS and system overheads; the proposed proximal term can attenuate the effect of local update dispersion, enabling the training to quickly converge to the global optimum; design a new partial-greedy based participant selection mechanism, which reduces the complexity of federated aggregation and endows the training with sufficient exploration ability.

2. The method of joint computation offloading and resource allocation in multi-edge smart communities with personalized federated deep reinforcement learning according to claim 1, wherein the proposed system of multi-edge smart communities consists of a Central Base Station (C-BS) and m smart communities, denoted by the set R={Rᵢ, i∈m}; in the smart community Rᵢ, an Access Point (AP) interacts with the C-BS and there are n EDs, denoted by the set EDᵢ={ED_{i,j}, i∈m, j∈n}; each AP is equipped with an MEC server (denoted by Mᵢ) that can process the tasks offloaded by EDs and feedback results, and it can also transmit energy to the EDs within its communication coverage through the wireless network, each ED is equipped with a rechargeable battery that can receive and store energy to power the processes of task offloading and processing;
adopt a discrete-time running mode, which contains H time-slots with the same span, where h=1, 2, . . . , H; at the beginning of h, ED_{i,j} generates a task, denoted by Task_{i,j} (h)=(D_{i,j} (h), C_{i,j} (h), T_{d}), where D_{i,j} (h) indicates the data volume, C_{i,j} (h) indicates the required computational resources, and T_{d} indicates the maximum tolerable delay; if a task cannot be completed within maximum tolerable delay and available power, it will be determined to be failed; the tasks generated by ED_{i,j} will be placed in its buffer queue, and the tasks that first enter the queue will be completed before subsequently arriving tasks can be executed; tasks can be processed locally or offloaded to the MEC server for execution; divide each time-slot into T sub-slots for fine-grained model training, where t=1, 2, . . . , T, aiming to avoid excessive delays or task failures caused by inappropriate coarse-grained decisions; when there are more sub-slots, the waiting time for the tasks on the buffer queue might be reduced with better policies, but it will increase the complexity and time of model training, the values of T should be properly chosen for different requirements and scenarios.

3. The method of joint computation offloading and resource allocation in multi-edge smart communities with personalized federated deep reinforcement learning according to claim 2, wherein when uploading Task_{i,j}(h) to Mᵢ for execution via the AP in Rᵢ, the uplink date rate of ED_{i,j} is defined as
$${r}_{i , j} ( t ) = {w}_{i , j} ( t ) {B}_{i} ( t ) {log}_{2} ( 1 + \frac{{P}_{i , j} ( t ) {g}_{i , j} ( t )}{{σ}^{2} {l}_{i , j} ( t )} ) \qquad ( 1 )$$
where Bᵢ(t) indicates the available upload bandwidth at the sub-slot t, w_{i,j}(t) indicates the proportion of bandwidth allocated to Task_{i,j}(h), P_{i,j}(t) indicates the transmission power of ED_{i,j}, g_{i,j}(t) indicates the channel gain between Mᵢ and ED_{i,j}, σ² indicates the average power of Gaussian white noise, and l_{i,j}(t) indicates the distance between Mᵢ and ED_{i,j};
the delay of uploading Task_{i,j}(h) is defined as
$${T}_{i , j}^{tr} ( h ) = \frac{{D}_{i , j} ( h )}{{r}_{i , j} ( t )} \qquad ( 2 )$$
accordingly, the energy consumption of uploading Task_{i,j}(h) is defined as
$${E}_{i , j}^{tr} ( h ) = {P}_{i , j} ( t ) {T}_{i , j}^{tr} ( t ) . \qquad ( 3 )$$

4. The method of joint computation offloading and resource allocation in multi-edge smart communities with personalized federated deep reinforcement learning according to claim 2, wherein in the proposed model, all EDs and MEC servers can offer computing services, thus consider the local and edge computing modes as follows:
when a task is executed on an ED, the delay and energy consumption of executing the task are defined as
$${T}_{i , j}^{l} ( h ) = \frac{{C}_{i , j} ( h )}{{f}_{i , j}} \qquad ( 4 )$$
$${E}_{i , j}^{l} ( h ) = {kC}_{i , j} ( h ) {f}_{i , j}^{2} \qquad ( 5 )$$
where f_{i,j} indicates the computing capability (i.e., CPU frequency) of ED_{i,j} and k is the capacitance coefficient;
when offloading a task to the MEC server for execution, the delay and energy consumption of executing the task are defined as
$${T}_{i , j}^{m} ( h ) = \frac{{C}_{i , j} ( h )}{{β}_{i , j} ( t ) {F}_{i} ( t )} \qquad ( 6 )$$
$${E}_{i , j}^{m} ( h ) = {P}_{m} {T}_{i , j}^{m} ( h ) \qquad ( 7 )$$
where β_{i,j}(t) indicates the proportion of computational resources allocated by Mᵢ to Task_{i,j}(h), Fᵢ(t) indicates the available computational resources of Mᵢ, and Pₘ indicates the computing power of Mᵢ.

5. The method of joint computation offloading and resource allocation in multi-edge smart communities with personalized federated deep reinforcement learning according to claim 2, wherein in the proposed system, all EDs are equipped with rechargeable batteries with a maximum capacity of bₘₐₓ; at the beginning of t, the battery power of ED_{i,j} is b_{i,j}(t); during the process of harvesting energy, ED_{i,j} receives energy through WPT and deposits it into the battery in the form of energy packets, and the amount of harvested energy by an ED during t is denoted as eₜ, which can be used to execute tasks locally or offload tasks to Mᵢ for execution; for different system states during t, consider different situations of power variations on ED_{i,j} as follows;
if the task buffer queue of ED_{i,j} is empty, there is only charging but no energy consumption; thus, at the beginning of t+1, the battery power of ED_{i,j} is
$${b}_{i , j} ( t + 1 ) = min ( {b}_{i , j} ( t ) + {e}_{t} , {b}_{max} ) \qquad ( 8 )$$
if Task_{i,j}(h) is completed on ED_{i,j}, the battery power of ED_{i,j} at the beginning of t+1 is
$${b}_{i , j} ( t + 1 ) = min \{ max \{ {b}_{i , j} ( t ) + {e}_{t} - {E}_{i , j}^{l} ( h ) , 0 \} , {b}_{max} \} \qquad ( 9 )$$
if Task_{i,j}(h) fails on ED_{i,j} because T_{i,j}^{l}(h) exceeds T_{d} or E_{i,j}^{l}(h) exceeds b_{i,j}(t), the battery power of ED_{i,j} at the beginning of t+1 is
$${b}_{i , j} ( t + 1 ) = min \{ max \{ {b}_{i , j} ( t ) + {e}_{t} - {E}_{i , j}^{l} ( h ) , 0 \} , {b}_{max} \} \qquad ( 10 )$$
if Task_{i,j}(h) is offloaded to Mᵢ and be completed successfully, the battery power of ED_{i,j} at the beginning of t+1 is
$${b}_{i , j} ( t + 1 ) = min \{ max \{ {b}_{i , j} ( t ) + {e}_{t} - {E}_{i , j}^{tr} ( h ) - {E}_{i , j}^{m} ( h ) , 0 \} {b}_{max} \} \qquad ( 11 )$$
if Task_{i,j}(h) fails because T_{i,j}^{tr}(h) exceeds T_{d} or E_{i,j}^{tr}(h) exceeds b_{i,j}(t), the battery power of ED_{i,j} at the beginning of t+1 is
$${b}_{i , j} ( t + 1 ) = min \{ max \{ {b}_{i , j} ( t ) + {e}_{t} - \frac{\frac{h}{T}}{{T}_{i , j}^{tr} ( h )} {E}_{i , j}^{tr} ( h ) , 0 \} , {b}_{max} \} \qquad ( 12 )$$
if Task_{i,j}(h) fails on Mᵢ because T_{i,j}^{m}(h) exceeds T_{d} or E_{i,j}^{m}(h) exceeds b_{i,j}(t), the battery power of ED_{i,j} at the beginning of t+1 is
$${b}_{i , j} \text{} ( \text{} t + \text{} 1 ) = min \text{} \{ max \{ {b}_{i , j} ( t ) + {e}_{t} - {E}_{i , j}^{tr} ( h ) - \frac{\frac{h}{T} - {T}_{i , j}^{tr} ( h )}{{T}_{i , j}^{m} ( h )} {E}_{i , j}^{tr} ( h ) , 0 \} , {b}_{max} \} . \qquad ( 13 )$$

6. The method of joint computation offloading and resource allocation in multi-edge smart communities with personalized federated deep reinforcement learning according to claim 2, wherein based on the above system models, the delay and energy consumption of executing a task with different offloading decisions are respectively defined as
$${T}_{i , j} ( h ) = ( 1 - {α}_{i . j} ( t ) ) {T}_{i , j}^{l} ( h ) + {α}_{i , j} ( t ) ( {T}_{i , j}^{tr} ( h ) + {T}_{i , j}^{m} ( h ) ) \qquad ( 14 )$$
$${E}_{i , j} ( h ) = ( 1 - {α}_{i , j} ( t ) ) {E}_{i , j}^{l} ( h ) + {α}_{i , j} ( t ) ( {E}_{i , j}^{tr} ( h ) + {E}_{i , j}^{m} ( h ) ) \qquad ( 15 )$$
where α_{i,j}(t)∈{0, 1} is the offloading decision, which indicates that a task will be executed locally or offloaded to the MEC server for execution; to minimize the delay and energy consumption of executing tasks, the optimization objective is formulated as
$$( P 1 ) {min}_{α , β , ω} {\sum }_{j = 1}^{n} {\sum }_{h = 0}^{H} {q}_{i , t} {T}_{i , j} ( h ) + {q}_{i , e} {E}_{i , j} ( h ) \qquad ( 16 )$$
$$s . t . C 1 : {α}_{i , j} ( t ) ∈ \{ 0 , 1 \}$$
$$C 2 : {T}_{i , j} ( h ) \leq {T}_{d}$$
$$C 3 : {E}_{i , j} ( h ) \leq {b}_{i , j} ( t )$$
$$C 4 : {\sum }_{i = 1}^{N} {α}_{i , j} ( t ) {ω}_{i , j} ( t ) = 1$$
$$C 5 : {\sum }_{i = 1}^{N} {α}_{i , j} ( t ) {β}_{i , j} ( t ) = 1$$
where q_{i,t} and q_{i,e} indicate the weights of delay and energy consumption, respectively; C1 indicates that a task can only be executed locally or offloaded to the MEC server for execution; C2 indicates that the delay of executing a task cannot exceed the maximum tolerable delay; C3 indicates that the energy consumption of executing a task cannot exceed the available battery power of an ED; C4 indicates that the sum of the proportion of bandwidth allocated for uploading tasks should be 1; C5 indicates that the sum of the proportion of the computational resources allocated for executing offloaded tasks should be 1.

7. The method of joint computation offloading and resource allocation in multi-edge smart communities with personalized federated deep reinforcement learning according to claim 1, wherein the DRL agent selects actions under different states by interacting with the single-edge environment and continuously optimizes the policies of computation offloading and resource allocation referring to the reward signals from the environment; accordingly, the state space, action space, and reward function for DRL are defined as follows;
state space: at sub-slot t, the system state is defined as
$${s}_{i} ( t ) = \{ {D}_{i} ( t ) , {C}_{i} ( t ) , {b}_{i} ( t ) , {l}_{i} ( t ) , {B}_{i} ( t ) , {F}_{i} ( t ) , {q}_{i} \} \qquad ( 17 )$$
where Dᵢ(t)={D_{i,j}(t), j∈N} indicates the set of data volumes for all tasks, Cᵢ(t)={C_{i,j}(t), j∈N} indicates the set of required computational resources for all tasks, bᵢ(t)={b_{i,j}(t), j∈N} indicates the set of battery power for all EDs, lᵢ(t)={l_{i,j}(t), j∈N} indicates the set of distances between Mᵢ and all EDs, Bᵢ(t) and Fᵢ(t) indicate the available bandwidth and computational resources of Mᵢ, respectively, and qᵢ={q_{i,t}, q_{i,e}, q_{i,p}} indicates the personalized demands for delay, energy consumption, and task success rate;
action space: at sub-slot t, the DRL agent makes an action of computation offloading and resource allocation based on the current system state, which is defined as
$${a}_{i} ( t ) = \{ {α}_{i} ( t ) , {ω}_{i} ( t ) , {β}_{i} ( t ) \} \qquad ( 18 )$$
where αᵢ(t) indicates the set of offloading decisions for all tasks, and wᵢ(t) and βᵢ(t) indicate the sets of the proportion of bandwidth and computational resources allocated to all tasks, respectively;
reward function: the optimization objective of P1 is to minimize the weighted sum of delay and energy consumption; thus, at sub-slot t, the instant reward of processing a task is defined as
$${r}_{i , j} ( t ) = \{ \begin{matrix}- ( {q}_{i , t} {T}_{i , j} ( h ) + {q}_{i , e} {E}_{i , j} ( h ) ) , & Succeed \\ - {q}_{i , p} , & Unsatisfy C 2 \\ - {q}_{i , p} , & Unsatisfy C 3\end{matrix} \qquad ( 19 )$$
if a task can be successfully completed, the instant reward will be the opposite of the weighted sum of delay and energy consumption; if C2 or C3 cannot be satisfied, the instant reward will be q_{i,p}, which is used as the penalty for failing to complete the task; the long-term reward is defined as
$${r}_{i} ( t ) = {\sum }_{j = 1}^{N} {\sum }_{h = 1}^{H} {γ}^{t} {r}_{i , j} ( t ) \qquad ( 20 )$$
where γ^{t} is the discount factor.

8. The method of joint computation offloading and resource allocation in multi-edge smart communities with personalized federated deep reinforcement learning according to claim 7, wherein the main steps of the proposed improved twin-delayed DRL-based computation offloading and resource allocation algorithm as follows: first, the actor's network μᵢ and two critic's networks Q_{i,1} and Q_{i,2} are initialized, and the target actor's network μᵢ′ and two target critic's networks Q_{i,1}′ and Q_{i,2}′ are initialized accordingly; introduce two critic's networks that separate action selection and Q-value update, aiming to improve the training stability; than initialize the number of training epoch P, the number of time-slots H, the number of sub-slots T, the update frequencies of FL fₚ and the actor's network fₐ, the replay buffer Gᵢ, the batch size N and the learning rate τ; for each training epoch, when it comes to the round of FL update, μᵢ(s|θ^{μ}^{ᵢ}), Q_{i,1}(s, a|θ^{Q}^{_{i,1}}), and Q_{i,2}(s, a|θ^{Q}^{_{i,2}}) are uploaded to the C-BS; next, obtain aggregated models Q_{f,1}(s, a|θ^{Q}^{_{f,1}}), Q_{f,2}(s, a|θ^{Q}^{_{f,2}}), and μ_{f}(s|θ^{μ}^{_{f}}), which are used to replace local models by soft update; for each sub-slot, the state sᵢ(t) is first input to μᵢ to obtain an action of computation offloading and resource allocation aᵢ(t) and execute this action in the environment, which will feedback the instant reward and the next state sᵢ(t+1) based on execution results; next, the state-transition process is stored in Gᵢ, where N samples are randomly selected to train network parameters, and then the target actor's network is used to get the next action; the proposed algorithm uses the critic's network to fit Qᵢ(s(t), a(t)), which can accurately reflect the Q-values of each action; use the actor's network to fit the mapping between s(t) and a(t), and thus the DRL agent can take proper actions at different states and maximize the long-term reward; introduce the Gaussian noise in the target actor's network to obtain a(t+1), and this process is defined as
$${a}_{i} ( t + 1 ) = {μ}_{i} ( s ( t + 1 ) \vert {θ}^{{μ}_{i}^{′}} ) + {ε}_{2} , {ε}_{2} ∼ clip ( N ( 0 , {σ}_{2} ) , - c , c ) \qquad ( 21 )$$
where the actor's network is endowed with sufficient exploration of selecting target actions by adding noise;
the target Q-value is calculated by considering the current reward and comparing two critic's networks, which is defined as
$${𝓎}_{target} ← r ( t ) + γ {min}_{z = 1 , 2} {Q}_{i , z} ( s ( t + 1 ) , a ( t + 1 ) \vert {θ}^{{Q}_{i , z}^{′}} ) \qquad ( 22 )$$
the critic's network is updated by the loss back-propagated of the difference between y_{target} and the current Q-value; design a proximal term to replace the original loss function that only tends to minimize the difference in local Q-values, the update process is defined as
$${θ}^{{Q}_{i , z}} ← {arg min}_{{θ}_{i , z}} ( {N}^{- 1} \sum {( {𝓎}_{target} - {Q}_{i , z} ( s ( t ) , a ( t ) \vert {θ}^{{Q}_{i , z}} ) )}^{2} ) + \frac{{λ}_{{Q}_{i , z}}}{2} {‖ {θ}^{{Q}_{i , z}} - {θ}^{{Q}_{f , z}} ‖}^{2} . \qquad ( 23 ) .$$

9. The method of joint computation offloading and resource allocation in multi-edge smart communities with personalized federated deep reinforcement learning according to claim 7, wherein design a new personalized FL-based training framework to further improve the adaptiveness and training efficiency of the DRL-based computation offloading and resource allocation model for different environments; the proposed personalized FRL-based training framework as follow: initialize the federated actor's network μ_{f}, two federated critic's networks Q_{f,1} and Q_{f,2}, the number of edges participating in FRL training K (K≤m), and the communication rounds for federated aggregation P_{f}; in each communication round, introduce a new proximal term to attenuate the dispersion of local updates, the process is defined as
$${θ}_{i}^{t + 1} \approx {min}_{{θ}_{i}^{t}} {h}_{i}^{t} ( {θ}_{i}^{t} ; {θ}_{f}^{r} ) = L ( {θ}_{i}^{t} ) + \frac{{λ}_{{θ}_{i}}}{2} {‖ {θ}_{i}^{t} - {θ}_{f}^{r} ‖}^{2} \qquad ( 24 )$$
where λ_{θ}_{ᵢ}={λ_{Q}_{_{i,1}}, λ_{Q}_{_{i,2}}, λ_{μ}_{ᵢ}} is the parameter set of the proximal term, use an adaptive tuning of λ_{θ}_{ᵢ}, indicating the loss changes of local models, to solve the issue of model heterogeneity; this design limits the iterative trajectories of local agents to avoid the training dispersion caused by the deviation of local models; in each communication round, each DRL model in Rᵢ(Rᵢ∈R) uploads the actor's network μᵢ(s|θ^{μ}^{ᵢ}) and two critic's networks Q_{i,1}(s, a|θ^{Q}^{_{i,1}}), and Q_{i,2}(s, a|θ^{Q}^{_{i,2}}) to the C-BS; next, sort DRL models by ascending order of their training loss, and then design a partial-greedy based participant selection mechanism, where the C-BS uses ε-greedy to select some DRL models for federated aggregation; select the DRL model with the lowest training loss by the probability of ε and randomly select DRL models in the other cases; the process of federated aggregation is defined as
$${Q}_{f , 1} ( s , a \vert {θ}^{{Q}_{f , 1}} ) = \frac{1}{K} {\sum }_{i ∈ {Z}_{r}} {Q}_{i , 1} ( s , a \vert {θ}^{{Q}_{i , 1}} ) , \qquad ( 25 )$$
$${Q}_{f , 2} ( s , a \vert {θ}^{{Q}_{f , 2}} ) = \frac{1}{K} {\sum }_{i ∈ {Z}_{r}} {Q}_{i , 2} ( s , a \vert {θ}^{{Q}_{i , 2}} ) ,$$
$${μ}_{f} ( s \vert {θ}^{{μ}_{f}} ) = \frac{1}{K} {\sum }_{i ∈ {Z}_{r}} {μ}_{i} ( s \vert {θ}^{{μ}_{i}} ) .$$
the C-BS distributes the aggregated DRL models to the DRL agents in each Rᵢ(Rᵢ∈R) and waits for the next communication round of FRL training.
